(19) United States
(12) Patent Application Publication
(10) Pub. No.: US 2014/0349061 A1
(43) Pub. Date: Nov. 27, 2014

(54) HYDROPHOBIC SURFACES ON INJECTION MOLDED OR SHAPED ARTICLES

(71) Applicant: Ross Technology Corporation, Leola, PA (US)

(72) Inventors: Vinod K. SIKKA, Oak Ridge, TN (US); Andrew K. JONES, Lancaster, PA (US)

(21) Appl. No.: 14/454,795

(22) Filed: Aug. 8, 2014

Related U.S. Application Data
(63) Continuation of application No. PCT/US13/25408, filed on Feb. 8, 2013.
(60) Provisional application No. 61/596,547, filed on Feb. 8, 2012.

(51) Int. Cl. B29C 33/56; B29C 33/42

(52) U.S. Cl. CPC B29C 33/56; B29C 33/424; B29K 2023/12
USPC 428/98; 264/39

(57) ABSTRACT

This disclosure describes the preparation of durable superhydrophobic and superoleophobic surfaces by forming or molding superhydrophobic particles into plastics, metals, and other materials. The molding and forming process can also impart a texture or pattern into the formed or molded surface as desired to increase the durability of superhydrophobic and/or superoleophobic effect.

Articles and parts are often prepared by manufacturing processes that include pressing, stamping, rolling, molding (e.g., casting, injection molding or extrusion molding) etc. to shape some or all of an article or to impart a pattern or texture to some or all of an article's surface. Described herein is technology that permits the formation of articles having at least a portion of their surface rendered hydrophobic (HP) or superhydrophobic (SH). In embodiments described herein, such surfaces also are rendered oleophobic (OP) or superoleophobic (SOP) during such processes.

### SUMMARY

Plastics and other materials that are shaped by processes including molding and/or forming may be modified during such processes by impregnation of the formed materials with one or more materials that can render their surfaces HP or SH. In some embodiments of such processes, the surfaces also are rendered OP or SOP. As used herein, the abbreviation “HP/OP” means that the surface is (i) hydrophobic or superhydrophobic, and (ii) possibly also oleophobic or superoleophobic. Each of those terms is defined herein.

In one embodiment, this disclosure describes a method of preparing HP/OP areas on all or part of the surface of a molded object comprising: a) applying a coating composition comprising (i) optional first-particles that may impart surface properties such as durability and/or surface texture, and (ii) second-particles that impart HP/OP properties to all or part of the surface of a mold that will shape some or all of the object, thereby forming a coated mold surface; and b) introducing the material to be molded into the mold in a flowable state, thereby contacting at least a portion of the material with said coated mold surface.

In another embodiment this disclosure describes a method of preparing durable HP/OP areas on all or part of an object's surface that will be formed, such as by pressing, rolling, and/or stamping, in a method that comprises: a) applying a coating composition as described above (i.e., comprising second-particles and optional first-particles) to all or part of the surface of (i) the pressing, rolling or stamping surface that will contact the material to be formed into all or part of the object, and/or (ii) the surface of the material to be pressed, rolled or stamped into all or part of the object; and b) pressing, rolling or stamping the material to form all or part of the object.

### BRIEF DESCRIPTION OF THE DRAWINGS

FIG. 1 is a micrograph showing a PP (polypropylene) plate (sheet) processed with sandblasted texture as described in Example 1, part A.

FIG. 2 is a micrograph showing a PP plate (sheet) processed with laser textured plates as described in Example 1 part B.

FIG. 3 is a micrograph showing an aluminum plate (sheet) coated with a polyurethane coating and textured with a fabric plates as described in Example 1 part C.

### DETAILED DESCRIPTION

### 1. Overview

Described herein is a process for preparing objects with HP/OP surfaces. Embodiments herein provide such surfaces in which the HP/OP properties are durable and can remain despite wear to the surface. The objects (articles) can be prepared by a variety of methods including: molding (e.g., casting) or forming (pressing or impressing, rolling, and/or stamping) of nano-scale superhydrophobic particles into the surface of the article. The methods can be applied to a wide range of plastics and other materials. In some embodiments the processes may impart a pattern or micro-pattern into some or all of the article surface. The pattern or micro-pattern may be formed by imparting (e.g., by engraving or etching) the corresponding pattern into the surface(s) of molds, dies, plates etc. used in molding or forming processes that are contacted with the materials in the molding or forming process.

The processes described herein optionally include the introduction of “first-particles” having an average size range from about 1 micron to about 250 microns, which particles may provide desired surface properties such durability and texture. These first-particles, which are typically greater than 25 microns in diameter, are described further below.

The processes described herein do comprise the introduction of second-particles into all or part of an object or article surface. Second-particles have an average size from about 1 nm to about 1 micron and comprise one or more types of functionalities that render them HP/OP such as alkyl or fluoroalkyl groups introduced by reaction with alkyl or fluorinated alkyl silanes (silanes bearing alkyl and/or fluorinated alkyl groups). In one embodiment, the functionalities are introduced using silanizing agents of formula I (below), and/or one or more siloxanes. In another embodiment the second-particles may comprise one or more types of hydrocarbon and/or fluorinated hydrocarbons independently selected from hydrocarbon and/or fluorinated hydrocarbons having a 1-4, 1-8, 1-12, 1-16, 3-8, 3-16, 2-18, 5-10, 7-20, 10-22, 12-24 or 14-24, carbon atoms.

### 1.1 DEFINITIONS

For the purposes of this disclosure, a HP material or surface is one that results in a water droplet forming a surface contact angle exceeding about 90° at room temperature (which is about 23° C. for purposes of this disclosure). Similarly, for the purposes of this disclosure, a SH material or surface is one that results in a water droplet forming a surface contact angle exceeding 150° but less than the theoretical maximum contact angle of 180° at room temperature. As SH surface behavior encompasses water contact angles from about 150° to about 180°, SH behavior is considered to include what is sometimes referred to as “ultrahydrophobic” behavior. For the purpose of this disclosure the term hydrophobic (HP) shall include superhydrophobic (SH) behavior unless stated otherwise.

For the purposes of this disclosure an OP material or surface is one that results in a droplet of light mineral oil forming a surface contact angle exceeding about 90°. Similarly, for the purposes of this disclosure a SOP material or surface is one that results in a droplet of light mineral oil forming a surface contact angle exceeding 150° but less than the theoretical maximum contact angle of 180° at room temperature. For the purpose of this disclosure the term oleophobic (OP) shall include superoleophobic (SOP) behavior unless stated otherwise.

As discussed below, some of the second-particles that impart HP properties may also impart OP properties. Therefore, surfaces, materials, and articles or objects described herein that display HP behavior possibly may also display OP behavior. The abbreviation HP/OP is used herein to designate surfaces, materials, and articles or objects that are hydrophobic and possibly also oleophobic. Accordingly, the abbreviation HP/OP also refers to surfaces, materials, and articles or objects that are superhydrophobic (SH) and possibly also oleophobic (OP) or superoleophobic (SOP).

A “flowable state” is a state in which material to be formed is (i) in a liquid, plastic, semi-solid, solid, particulate, or powder that can take the shape of a mold or other surface use to shape or form the material, or (ii) in a state that can be deformed to conform substantially to the shape of a mold or other surface.

Flowable materials are materials that are in a flowable state until they set or become solid (e.g., by cooling below the melting point, setting by polymerization, or experiencing a reduction in the applied pressure).

First-particles are particles that are optionally added to alter the properties of the material being shaped or formed other than the HP/OP properties. For example to increase the wear resistance, act as a filler, and/or enhance the surface roughness and resistance to loss of HP/OP properties. First-particles generally have a size greater than about 25 μm, but may be smaller. First-particles are described in more detail below.

Second-particles are particles that comprise, or are associated with, hydrophobic and/or oleophobic compounds or moieties (i.e., moieties that are covalently or non-covalently bound). Second particles typically have a size from about 1 nm up to about 25 μm. Second-particles are described in more detail below.

Precursors of second-particles are particles that can be converted into second particles by treatment with compositions that will cause the particles to bear or to be associated with hydrophobic and possibly also oleophobic compounds or moieties (e.g., silanizing agents or siloxanes).

Mold or molding as used herein is directed to processes such as casting where materials in a flowable state, typically liquid, plastic, or semi-solid, are introduced into a mold or die until they are sufficiently set as a solid or semi-solid that upon separation or removal from the mold or die will substantially retain the shape imparted by the mold or die.

Forming, as used herein encompasses processes including pressing, stamping, embossing, and rolling that alter the shape and/or the texture of an object and/or its surface. Forming processes are typically applied to materials that are solid but may also be applied to flowable materials or materials that are solid, for example at room temperature (about 18-24° C.), but are in a flowable state under the temperature and/or pressure used in the forming process.

Anti-icing (AI) surfaces are HP/OP surfaces that are resistant to ice formation or prevent ice that forms from adhering to the surface (i.e., ice that forms can be removed with a minimum of force) relative to surfaces that are substantially the same as the AI surface but do not bear second particles that impart HP/OP properties.

For the purpose of this disclosure HP denotes hydrophobic (including superhydrophobic) properties as well as anti-icing properties.

Durability, unless stated otherwise, refers to the resistance to loss of hydrophobic properties due to mechanical abrasion.

Hydrocarbon as used herein denotes a compound, group or moiety that is comprised of hydrogen and carbon atoms. Hydrocarbons can be fluorinated, in which case they comprise one or more fluorine atoms in place of hydrogen atoms (e.g., fluorinated alkanes). Where hydrocarbons are perfluorinated all hydrogen atoms have been replaced by fluorine atoms.

Alkyl as used herein denotes a linear or branched alkyl radical. Alkyl groups may be independently selected from C₁ to C₂₀ alkyl, C₂ to C₂₀ alkyl, C₄ to C₂₀ alkyl, C₆ to C₁₈ alkyl, C₆ to C₁₆ alkyl, or C₆ to C₂₀ alkyl. Unless otherwise indicated, alkyl does not include cycloalkyl. Cycloalkyl groups may be independently selected from: C₄ to C₂₀ alkyl comprising one or two C₄ to C₈ cycloalkyl functionalities; C₆ to C₂₀ alkyl comprising one or two C₄ to C₈ cycloalkyl functionalities; C₆ to C₁₈ alkyl comprising one or two C₄ to C₈ cycloalkyl functionalities; C₆ to C₁₆ alkyl comprising one or two C₄ to C₈ cycloalkyl functionalities. One or more hydrogen atoms of the alkyl groups may be replaced by fluorine atoms to form fluoroalkyl groups.

Haloalkyl as used herein denotes an alkyl group in which some or all of the hydrogen atoms present in an alkyl group have been replaced by halogen atoms. Halogen atoms may be limited to chlorine or fluorine atoms in haloalkyl groups.

Fluoroalkyl as used herein denotes an alkyl group in which some or all of the hydrogen atoms present in an alkyl group have been replaced by fluorine atoms.

Perfluoroalkyl as used herein denotes an alkyl group in which fluorine atoms have been substituted for each hydrogen atom present in the alkyl group.

### 2. Materials and Objects Subject to Molding and Forming

The molding and forming processes described herein may be used to render a large variety of materials HP/OP. Virtually any material that is flowable and which solidifies (e.g., by cooling or by chemical reaction) can be rendered HP/OP by the molding processes described herein. Similarly, forming, such as by stamping, pressing and rolling processes, which include impressing and embossing, may employ virtually any solid material that can be subject to shaping by those processes. Those materials include plastics, resins, metals, metal alloys, and rubbers.

A broad range of plastics may also be used in the molding and forming process described herein, including but not limited to, elastomers, common thermoset plastics such as epoxies and phenolics, and thermoplastics such as nylon, polyethylene, polypropylene, polyesters, polystyrene and mixtures comprising any one or more, two or more, or three or more of those plastics.

Metals that may be employed in the molding or forming processes include, but are not limited to, aluminum, antimony, chromium, cobalt, copper, gold, iron, lead, magnesium, manganese, molybdenum, nickel, chromium, platinum, palladium, rhenium, rhodium, iridium, silver, tin, tungsten, vanadium, zinc, and alloys thereof, including, but not limited to, brasses, bronzes, stainless steel, and carbon steel.

Among the limitations on the molding and forming processes are the nature and properties of the first and second-particles, and in some instances the physical (e.g., pressure and/or temperature) and chemical condition of the molding and forming process. For molding and forming processes, the pressures and temperature at which the materials transition between solid and flowable states in which first and/or second-particles can be joined with the material's surface is deserves consideration.

Where molding and/or forming processes (e.g., pressing, stamping, rolling) do not require applying pressure or heating material to a temperature where first and/or second particles may become damaged, they are not generally subject to the same constraints as molding or forming at elevated temperatures.

Where molding processes employ materials with a melting temperature greater than the temperature where moieties imparting HP/OP behavior to second-particles are stable, (e.g., materials requiring molding above about 450° C., such as metals and/or metal alloy materials) it may be desirable to employ coating compositions with particles that can act as precursors of second-particles. In such cases the mold or die is treated with a coating composition comprising precursors of second-particles (e.g., fumed silica), and second-particles are prepared by post-molding treatment with, for example, a silanizing agent when the molded object has been sufficiently cooled. Depending on the hydrophobic moiety involved, and the length of time second-particles would be exposed to the molding temperature, the use of precursors of second-particles may be considered where the melting point of the materials is greater than about 150°, 200°, 250°, 300°, 350°, 400°, or 430° C. After the molded object is set and sufficiently cooled it can be treated with an agent (e.g., a silanizing agent) that will modify the second-particles (and possibly first-particles if present) and render the portion of the object HP/OP.

When it is deemed desirable to heat materials used in forming processes, concerns similar to those discussed for casting at elevated temperatures may be raised. The forming of heated materials with second particles that are sensitive to the temperature employed may be accomplished by limiting the time second-particles are subject to damaging temperatures. This may be accomplished by spraying the material on the surface of the material just prior to it entry into the forming equipment or even on to the surface of rollers, dies, or plates used in forming processes. Alternatively, in embodiments where forming processes employ elevated temperatures it may be desirable to use precursors of second particles to coat some or all of the forming surface that will contact the heated material. The surface of the shaped material can be subsequently treated with an agent that will convert the precursors of second particles to second particles (e.g., a silanizing agent) following forming. Alternatively, it may be desirable to apply the coating composition comprising second particles or precursors of second particles to the material to be formed, (e.g., when using heated forming equipment), thereby limiting the time the second-particles will be subject to heating. In such an embodiment, where precursors of second particles are employed it will be necessary to convert them to second particles by post forming treatments such as contacting the formed surface with a silanizing agent.

2.1 Plastics

A wide variety of resins, thermoplastic elastomers, thermoplastics and thermoset plastics (thermoset resins) are compatible with the molding, pressing, rolling and stamping process described herein for the preparation of objects with all or part of their surfaces rendered HP/OP. Among the common thermoplastics whose surfaces may be made HP/OP are: Polyamide (PA or Nylon), Polybutylene terephthalate (PBT), Polyethylene terephthalate (PET), Polycarbonate (PC), Polyethylene (PE), Polypropylene (PP), and Polyvinyl Chloride (PVC). The surface of a variety of thermoplastic elastomers may also be made HP/OP by the processes described herein including, but not limited to, block copolymers (e.g., styrenics, copolyesters, polyurethanes and polyamides) and thermoplastic/elastomer blends and alloys (e.g., polyolefin blends and polyolefin alloys). A number of thermoset plastics may have their surfaces rendered HP/OP by the processes described herein including, but not limited to, Epoxies, Polyesters¹, Vinylesters, Polyurethanes, and Phenolics. Table 1 lists some plastics that may be utilized in the processes described herein to prepare objects where all or a portion of their surface is rendered HP/OP along with some of their properties and potential applications. ¹Depending on its specific chemical structure and composition, polyesters can be a thermoplastic or thermoset plastic; there are also polyester resins cured by hardeners. Many common polyesters are thermoplastics.

TABLE 1
Plastics

| Plastic Composition | Some Common Uses |
|---|---|
| Polyester (PES) | Fibers, textiles. |
| Polyethylene terephthalate (PET) | Carbonated drink bottles, bottles and packaging for food stuffs |
| | (e.g., peanut butter jars), plastic film, microwavable packaging |
| Polyethylene (PE) | Wide range of inexpensive uses including supermarket bags, |
| | plastic bottles |
| High-density polyethylene (HDPE) | Commercial bottles (detergent bottles and milk jugs) |
| Polyvinyl chloride (PVC) | Plumbing pipes, gutters, shower curtains, window frames, |
| | flooring |
| Polyvinylidene chloride (PVDC) (e.g., | Food packaging, with very low permeability to water vapor, |
| Saran) | flavor and aroma molecules, and oxygen compared with other |
| | plastics |
| Low-density polyethylene (LDPE) | Outdoor furniture, siding, floor tiles, shower curtains, clamshell |
| | packaging |
| Polypropylene (PP) | Bottle caps, drinking straws, yogurt containers, appliances, car |
| | fenders (bumpers), plastic pressure pipe systems |
| Polystyrene (PS) | Packaging foam, food containers, plastic tableware, disposable |
| | cups, plates, cutlery, CD and cassette boxes |
| High impact polystyrene (HIPS) | Refrigerator liners, food packaging, vending cups |
| Polyamides (PA) (Nylons) | Fibers, toothbrush bristles, fishing line, under-the-hood car |
| | engine moldings |
| Acrylonitrile butadiene styrene (ABS) | Electronic equipment cases (e.g., computer monitors, printers, |
| | keyboards), drainage pipe |
| Polycarbonate (PC) | Compact discs, eyeglasses, riot shields, security windows, |
| | traffic lights, lenses, centrifuge tubes |
| Polycarbonate/Acrylonitrile Butadiene | A blend of PC and ABS that creates a stronger plastic. Used in |
| Styrene (PC/ABS, a blend of PC and | car interior and exterior parts, and mobile phone bodies |
| ABS) | |
| Polyurethanes (PU) | Cushioning foams, thermal insulation foams, surface coatings, |
| | printing rollers |

Specialty plastics

| | |
|---|---|
| Melamine formaldehyde (MF, an | An aminoplastic used for instance in moldings (e.g., break- |
| aminoplastic used as a multi-colorable | resistant alternatives to ceramic cups, plates and bowls for |
| alternative to phenolics) | children) and the decorated top surface layer of paper laminates |
| | (e.g., Formica) |
| Plastarch material (PSM) | Biodegradable and heat resistant, thermoplastic composed |
| | of modified corn starch. Used in a wide variety of applications |
| | including food packaging (e.g., microwavable containers, |
| | industrial packaging, medical products and disposable items. |
| | Compatible with thermoforming, injection molding, |
| | blown film, and foaming applications. Particularly suitable |
| | where commercial composting is the preferred end of life |
| | option |
| Phenolics (PF) or (phenol | High modulus, relatively heat resistant, and excellent fire |
| formaldehydes) | resistant polymer. Used for insulating parts in electrical |
| | fixtures, paper laminated products (e.g., Formica), thermally |
| | insulation foams. It is a thermosetting plastic, with the familiar |
| | trade name Bakelite, that can be molded by heat and pressure |
| | when mixed with a filler-like wood flour or can be molded |
| | (cast) in its unfilled liquid form or molded (cast) as foam (e.g., |
| | Oasis). |
| Polyetheretherketone (PEEK | Strong, chemical- and heat-resistant thermoplastic, |
| | biocompatibility allows for use in medical implant |
| | applications, aerospace moldings |
| Polyetherimide (PEI) (e.g., Ultem) | A high temperature, chemically stable polymer that does not |
| | crystallize |
| Polylactic acid (PLA) | A biodegradable, thermoplastic converted into a variety of |
| | aliphatic polyesters derived from lactic acid which in turn can |
| | be made by fermentation of various agricultural products such |
| | as corn starch, once made from dairy products |
| Polymethyl methacrylate (PMMA) | Contact lenses, glazing (best known in this form by its various |
| | trade names around the world; e.g., Perspex, Oroglas, |
| | Plexiglas), aglets, fluorescent light diffusers, rear light covers |
| | for vehicles |
| Polytetrafluoroethylene (PTFE) | Heat-resistant, low-friction coatings, used in things like non- |
| | stick surfaces for frying pans, plumber's tape and water slides. |
| | It is more commonly known as Teflon. |
| Urea-formaldehyde (UF) | One of the aminoplasts used as a multi-colorable alternative to |
| | phenolics. Used as a wood adhesive (for plywood, chipboard, |
| | hardboard) and electrical switch housings. |

2.2 Metals

Metals and metal alloys, including those comprising aluminum, antimony, bismuth, lead, magnesium, selenium, tin, zinc, and alloys may be formed with at least a part of their surfaces HP/OP by casting the metals in molds coated with a composition comprising second-particles and optionally comprising first-particles.

In one embodiment, alloys having melting points between about 130° C. and about 450° C. or, in another embodiment, about 175° C. and about 430° C. are useful in preparing molded objects with at least a portion of their surfaces being HP/OP by the methods described herein. Among the alloys useful in such embodiments are those comprising: AlSn; AlZn; AgZn; AgSn; BiSnZn; BiSn; BiSb; SbZn; BiCd; CdAg; CdTI; CdZn; CuZn; SnPb; SnPb; PbAg; PbCu; PbSb; SnZn; SnSb; SnAg; SnCu; or SnSb. Some examples of such alloys are: Bi56% Sn40% Zn4%; Bi58% Sn42%; Bi60% Cd40%; Sn63% Pb37%; Sn70% Pb30%; Sn91% Zn9%; Sn92% Zn8% (a tin foil composition); Sn92% Sb8% (sometimes referred to as “white metal”); Sn96.5% Ag3.5%; Sn99.25% Cu0.75%; Sn95% Sb5%; and Sn95% Ag5%. It is possible to use metals, metal alloys, and other materials with higher melting points in the processes described herein, if for example the time the second particles are exposed to the high temperatures is limited and/or if precursors of second particles are employed, followed by a post-molding or forming treatment to convert the precursors of second particles into second particles.

2.3 Other Materials:

The molding and forming processes described herein may be applied to materials in addition to plastics and metals, including, but not limited to, silicones, rubbers, fabrics, coatings (e.g., paints including acrylic, epoxy, polyurethane, and enamel), powder coatings, and a variety of rubbers and rubber-like materials.

2.3.1 Painted Coatings

Coatings applied as liquids, such as acrylic, polyurethane, lacquer, and enamel type paints may be converted to HP/OP coatings by the application of a coating composition comprising second-particles, and optionally comprising first-particles, to all or part of the coating, followed by forming the surface. Forming the surface may be accomplished by a variety of means including, but not limited to, contacting the surface with stamping, pressing or rolling equipment that forms the surface. In addition to forcing the second-particles into contact with the coating material, the equipment may impart a texture to the surface. Achieving a surface texture either by the incorporation of first-particles or by the introduction of a surface texture imparted by the forming equipment in the range of 10 microns (e.g., Ra about 10 microns, see the ranges discussed with the molding and forming process below) can increase the ability of the surface to maintain its HP/OP performance even when subject to some abrasion.

In processes where coatings are applied as liquids, such as paints, the coating (e.g., paint) is generally allowed to dry or cure sufficiently to prevent the second-particles, and or first-particles if present, from being completely absorbed into the coating. The coating composition comprising second-particles, and optionally comprising first-particles, is then applied and the surface is subjected to forming, such as by pressing (impressing), stamping etc.

2.3.2 Fabrics

Fabrics, including, but not limited to, polyester, cotton polyester (50%/50%), and rayon, can be made to have HP/OP properties by the processes described herein. Imparting HP/OP properties into fabrics can be accomplished by applying a coating composition comprising second-particles, and optionally comprising first-particles, to the fabric, for example by spraying. Once applied to the fabric, the particles are incorporated into the fabric by applying heat and/or pressure (e.g., forming the fabric under pressure). The heat and/or pressure applied drives the particles into the fabric, and, where the fabric contains synthetic fiber that can melt, the second-particles may become bound to the synthetic portion of the fabric, increasing the durability of the HP/OP performance of the fabric relative to fabric that has been treated with the same particles but has not been subject to the heating and/or pressure. Where the fabric does not contain any synthetic fibers or sufficient synthetic fibers that can melt and bind the second-particles, thermoplastic particles (e.g., rayon, nylon, polyester and the like), or particles of thermoplastic elastomers can be applied in addition to the second-particles. When processed under pressure and/or heat, the particles can melt and bind the second-particles to the fabric, again increasing the durability of HP/OP performance.

Many fabrics have sufficient roughness in their weave that imparting a pattern into the fabric by forming is not necessary to impart HP/OP properties. Woven fabrics will generally have sufficient roughness to enhance the durability of the HP/OP properties of the fabrics. In some embodiments, fabrics with greater than 50, 75, 100, 150, 200, 250, 300, 400, 500 or 600 treads per inch will display durable HP/OP behavior. Where fabrics are not woven, but prepared by other means, it may be beneficial to impart a surface roughness (e.g., form a pattern or micropattern with an Ra on the order of 10 microns in the forming process to enhance the durability of the HP/OP properties relative to the same fabric that does not have a texture imparted.

2.4 Intermediary Substances:

When an article or object is comprised of a material that will not accept the molding or forming process without damage to the article, the second-particles, and/or first-particles if present (e.g., a metal such as steel), an intermediary layer of a resin, plastic, or other polymer may be used to create an HP/OP surface on the object.

In one embodiment, the resin, plastic, or other polymer is applied to all or part of the surface of the article followed by applying a coating composition comprising second-particles, and optionally comprising first-particles. The particles are incorporated into the resin, plastic, or other polymer by forming (e.g., by pressing, stamping or rolling). Alternatively, the coating composition comprising second-particles and optionally comprising first particles can be applied to all or part of the pressing, stamping or rolling equipment that will contact the resin, plastic, or other polymer applied to the article. In either case, in addition to incorporating the second particles into the resin, plastic, or other polymer, the action of the forming equipment can impart a texture (pattern or roughness) to the finished HP/OP surface. The imparted texture can result in an increased durability of HP/OP performance and AI (anti-icing) performance of the article relative to articles that have been treated in substantially the same manner, but have not been textured (e.g., a surface that has an Ra value less than about 1 micron).

In one embodiment, the process of using an intermediate material (e.g., a polypropylene film) to form an HP/OP coating on all or part of an article (e.g., a metal plate such as an aluminum plate) comprises the steps of: applying (e.g., by spraying) a coating composition comprising second-particles and optionally comprising first-particles to a mold or die (e.g., a roller, or a stamp); and contacting the mold or die with the intermediate material which is contacted with, attached to, or adhered to all or part of the surface of the article. In such an embodiment the mold or die can impart a texture to the surface that enhances the durability of the HP/OP and/or AI performance relative to a coating that is otherwise identical but has not been textured (e.g., has an Ra value less than about 1 micron). An alternative to the preceding method is to spray the coating composition on the intermediate material (e.g., a polypropylene film) that is contacted with, attached to, or adhered to all or part of the surface of the article (e.g., a metal plate such as an aluminum plate) and then to contact the intermediate material with a mold or die to press the particles into the intermediate material and impart a texture to the surface as desired.

In another embodiment HP/OP fabrics are formed by: applying a coating composition comprising second-particles and optionally comprising first-particles to a mold or die which is then contacted with a thermoplastic material (e.g., low density polyethylene (LDPE) as a powder or sheet) that is in contact with a fabric (e.g., a woven fabric such as cotton or unwoven fabric such as felt). Heat and/or pressure applied to the thermoplastic material in the forming process incorporates the second-particles into the fabric and produce a fabric with HP/OP properties that are more durable than fabric into which the particles are introduced in the absence of the thermoplastic material. Alternatively, the coating composition can be applied to the fabric in the presence of thermoplastic material and subject to heat and/or pressure in a forming process to incorporate the second-particles (and first particles if present) into the fabric.

### 3.0 First-Particles

A wide variety of first-particles may advantageously be added to the coating composition applied to molds, to the surfaces of the pressing, stamping, or rolling apparatus, to the surfaces that contact the material to be formed or a portion thereof, or to the surface of materials to be pressed stamped, or rolled. Among other things, first-particles can improve the durability of the HP/OP surfaces relative to surfaces prepared in their absence. First-particles that may be employed in the durable HP/OP coatings include, but are not limited to, particles comprising: wood (e.g., wood dust), glass, metals and metal alloys (e.g., iron, titanium, nickel, zinc, copper, tin, silver and alloys comprising any of the foregoing metals), metal oxides, metalloid oxides (e.g., silica), plastics (e.g., thermoplastics), carbides, nitrides, borides, spinets, diamonds, and fibers (e.g., glass fibers or carbon fibers). In addition to altering the durability of HP/OP, first particles can alter other properties of objects, for example, the incorporation of silver particles can be used to impart antibacterial properties.

Some commercially available first-particles that may be employed in the formation of the durable HP/OP coatings described herein include those in the following table.

TABLE 2
First-particles sizes, properties, and sources

| First | | | | Particle | | | | |
|---|---|---|---|---|---|---|---|---|
| Particle | First | First | | Size | | Crush | | |
| (Filler) | Particle | Particle | Density | Range | | Strength | | |
| ID | Type | Details | (g/cc) | (μm) | Color | (psi) | Source | Location |
| K1 | Glass | GPS^{a} | 0.125 | 30-120 | White | 250 | 3M ™ | St. Paul, MN |
| | Bubbles | | | | | | | |
| K15 | Glass | GPS^{a} | 0.15 | 30-115 | White | 300 | 3M ™ | St. Paul, MN |
| | Bubbles | | | | | | | |
| S15 | Glass | GPS^{a} | 0.15 | 25-95 | White | 300 | 3M ™ | St. Paul, MN |
| | Bubbles | | | | | | | |
| S22 | Glass | GPS^{a} | 0.22 | 20-75 | White | 400 | 3M ™ | St. Paul, MN |
| | Bubbles | | | | | | | |
| K20 | Glass | GPS^{a} | 0.2 | 20-125 | White | 500 | 3M ™ | St. Paul, MN |
| | Bubbles | | | | | | | |
| K25 | Glass | GPS^{a} | 0.25 | 25-105 | White | 750 | 3M ™ | St. Paul, MN |
| | Bubbles | | | | | | | |
| S32 | Glass | GPS^{a} | 0.32 | 20-80 | White | 2000 | 3M ™ | St. Paul, MN |
| | Bubbles | | | | | | | |
| S35 | Glass | GPS^{a} | 0.35 | 10-85 | White | 3000 | 3M ™ | St. Paul, MN |
| | Bubbles | | | | | | | |
| K37 | Glass | GPS^{a} | 0.37 | 20-85 | White | 3000 | 3M ™ | St. Paul, MN |
| | Bubbles | | | | | | | |
| S38 | Glass | GPS^{a} | 0.38 | 15-85 | White | 4000 | 3M ™ | St. Paul, MN |
| | Bubbles | | | | | | | |
| S38HS | Glass | GPS^{a} | 0.38 | 15-85 | White | 5500 | 3M ™ | St. Paul, MN |
| | Bubbles | | | | | | | |
| K46 | Glass | GPS^{a} | 0.46 | 15-80 | White | 6000 | 3M ™ | St. Paul, MN |
| | Bubbles | | | | | | | |
| S60 | Glass | GPS^{a} | 0.6 | 15-65 | White | 10000 | 3M ™ | St. Paul, MN |
| | Bubbles | | | | | | | |
| S60/HS | Glass | GPS^{a} | 0.6 | 11-60 | White | 18000 | 3M ™ | St. Paul, MN |
| | Bubbles | | | | | | | |
| A16/500 | Glass | Floated | 0.16 | 35-135 | White | 500 | 3M ™ | St. Paul, MN |
| | Bubbles | Series | | | | | | |
| A20/1000 | Glass | Floated | 0.2 | 30-120 | White | 1000 | 3M ™ | St. Paul, MN |
| | Bubbles | Series | | | | | | |
| H20/1000 | Glass | Floated | 0.2 | 25-110 | White | 1000 | 3M ™ | St. Paul, MN |
| | Bubbles | Series | | | | | | |
| D32/4500 | Glass | Floated | 0.32 | 20-85 | White | 4500 | 3M ™ | St. Paul, MN |
| | Bubbles | Series | | | | | | |
| Expancel | Plastic Micro- | Dry | 0.042 ± 0.004 | 30-50 | | | Akzo | Dist. by Eka |
| 551 DE 40 | spheres | Expanded | | | | | Nobel | Chem., Inc., |
| d42 | | | | | | | | Duluth, GA |
| Expancel | Plastic Micro- | Dry | 0.042 ± 0.002 | 30-50 | | | Akzo | Dist. by Eka |
| 551 DE 40 | spheres | Expanded | | | | | Nobel | Chem., Inc., |
| d42 ± 2 | | | | | | | | Duluth, GA |
| Expancel | Plastic Micro- | Dry | 0.07 ± 0.006 | 15-25 | | | Akzo | Dist. by Eka |
| 461 DE 20 | spheres | Expanded | | | | | Nobel | Chem., Inc., |
| d70 | | | | | | | | Duluth, GA |
| Expancel | Plastic Micro- | Dry | 0.06 ± 0.005 | 20-40 | | | Akzo | Dist. by Eka |
| 461 DE 40 | spheres | Expanded | | | | | Nobel | Chem., Inc., |
| d60 | | | | | | | | Duluth, GA |
| Expancel | Plastic Micro- | Dry | 0.025 ± 0.003 | 35-55 | | | Akzo | Dist. by Eka |
| 461 DET 40 | spheres | Expanded | | | | | Nobel | Chem., Inc., |
| d25 | | | | | | | | Duluth, GA |
| Expancel | Plastic Micro- | Dry | 0.025 ± 0.003 | 60-90 | | | Akzo | Dist. by Eka |
| 461 DET 80 | spheres | Expanded | | | | | Nobel | Chem., Inc., |
| d25 | | | | | | | | Duluth, GA |
| Expancel | Plastic Micro- | Dry | 0.030 ± 0.003 | 35-55 | | | Akzo | Dist. by Eka |
| 920 DE 40 | spheres | Expanded | | | | | Nobel | Chem., Inc., |
| d30 | | | | | | | | Duluth, GA |
| Expancel | Plastic Micro- | Dry | 0.025 ± 0.003 | 35-55 | | | Akzo | Dist. by Eka |
| 920 DET 40 | spheres | Expanded | | | | | Nobel | Chem., Inc., |
| d25 | | | | | | | | Duluth, GA |
| Expancel | Plastic Micro- | Dry | 0.030 ± 0.003 | 55-85 | | | Akzo | Dist. by Eka |
| 920 DE 80 | spheres | Expanded | | | | | Nobel | Chem., Inc., |
| d30 | | | | | | | | Duluth, GA |
| H50/10000 | Glass | Floated | 0.5 | 20-60 | White | 10000 | 3M ™ | St. Paul, MN |
| EPX | Bubbles | Series | | | | | | |
| iMK | Glass | Floated | 0.6 | 8.6-26.7 | White | 28000 | 3M ™ | St. Paul, MN |
| | Bubbles | Series | | | | | | |
| G-3125 | Z-Light | CM^{b} | 0.7 | 50-125 | Gray | 2000 | 3M ™ | St. Paul, MN |
| | Spheres ™ | | | | | | | |
| G-3150 | Z-Light | CM^{b} | 0.7 | 55-145 | Gray | 2000 | 3M ™ | St. Paul, MN |
| | Spheres ™ | | | | | | | |
| G-3500 | Z-Light | CM^{b} | 0.7 | 55-220 | Gray | 2000 | 3M ™ | St. Paul, MN |
| | Spheres ™ | | | | | | | |
| G-600 | Zeeo- | CM^{b} | 2.3 | 1-40 | Gray | >60000 | 3M ™ | St. Paul, MN |
| | spheres ™ | | | | | | | |
| G-800 | Zeeo- | CM^{b} | 2.2 | 2-200 | Gray | >60000 | 3M ™ | St. Paul, MN |
| | spheres ™ | | | | | | | |
| G-850 | Zeeo- | CM^{b} | 2.1 | 12-200 | Gray | >60000 | 3M ™ | St. Paul, MN |
| | spheres ™ | | | | | | | |
| W-610 | Zeeo- | CM^{b} | 2.4 | 1-40 | White | >60000 | 3M ™ | St. Paul, MN |
| | spheres ™ | | | | | | | |
| SG | Extendo- | HS^{c} | 0.72 | 30-140 | Gray | 2500 | Sphere | Chattanooga, |
| | sphere ™ | | | | | | One | TN |
| DSG | Extendo- | HS^{c} | 0.72 | 30-140 | Gray | 2500 | Sphere | Chattanooga, |
| | sphere ™ | | | | | | One | TN |
| SGT | Extendo- | HS^{c} | 0.72 | 30-160 | Gray | 2500 | Sphere | Chattanooga. |
| | sphere ™ | | | | | | One | TN |
| TG | Extendo- | HS^{c} | 0.72 | 8-75 | Gray | 2500 | Sphere | Chattanooga, |
| | sphere ™ | | | | | | One | TN |
| SLG | Extendo- | HS^{c} | 0.7 | 10-149 | Off | 3000 | Sphere | Chattanooga, |
| | sphere ™ | | | | White | | One | TN |
| SLT | Extendo- | HS^{c} | 0.4 | 10-90 | Off | 3000 | Sphere | Chattanooga, |
| | sphere ™ | | | | White | | One | TN |
| SL-150 | Extendo- | HS^{c} | 0.62 | 70 | Cream | 3000 | Sphere | Chattanooga, |
| | sphere ™ | | | | | | One | TN |
| SLW-150 | Extendo- | HS^{c} | 0.68 | 8-80 | White | 3000 | Sphere | Chattanooga, |
| | sphere ™ | | | | | | One | TN |
| HAT | Extendo- | HS^{c} | 0.68 | 10-165 | Gray | 2500 | Sphere | Chattanooga, |
| | sphere ™ | | | | | | One | TN |
| HT-150 | Extendo- | HS^{c} | 0.68 | 8-85 | Gray | 3000 | Sphere | Chattanooga, |
| | sphere ™ | | | | | | One | TN |
| KLS-90 | Extendo- | HS^{c} | 0.56 | 4-05 | Light | 1200 | Sphere | Chattanooga, |
| | sphere ™ | | | | Gray | | One | TN |
| KLS-125 | Extendo- | HS^{c} | 0.56 | 4-55 | Light | 1200 | Sphere | Chattanooga, |
| | sphere ™ | | | | Gray | | One | TN |
| KLS-150 | Extendo- | HS^{c} | 0.56 | 4-55 | Light | 1200 | Sphere | Chattanooga, |
| | sphere ™ | | | | Gray | | One | TN |
| KLS-300 | Extendo- | HS^{c} | 0.56 | 4-55 | Light | 1200 | Sphere | Chattanooga, |
| | sphere ™ | | | | Gray | | One | TN |
| HA-300 | Extendo- | HS^{c} | 0.68 | 10-146 | Gray | 2500 | Sphere | Chattanooga, |
| | sphere ™ | | | | | | One | TN |
| XI0M 512 | Thermo- | MPR^{d} | 0.96 | 10-100 | White | 508 | XIOM | West |
| | plastic | | | | | | Corp. | Babylon, |
| | | | | | | | | NY |
| XIOM 512 | Thermo- | MPR^{d} | 0.96 | 10-100 | Black | 508 | XIOM | West |
| | plastic | | | | | | Corp. | Babylon, |
| | | | | | | | | NY |
| CORVEL ™ | Thermo- | Nylon | 1.09 | 44-74 | Black | | ROHM | Philadelphia, |
| Black 78- | plastic | Powder | | | | | & HASS | PA |
| 7001 | | Coating | | | | | | |
| Micro-glass | Fibers | MMEGF^{e} | 1.05 | 16 × 120 | White | | Fibertec | Bridgewater, |
| 3082 | | | | | | | | MA |
| Micro-glass | Fibers | MMEGF^{e} | 0.53 | 10 × 150 | White | | Fibertec | Bridgewater, |
| 9007D | Silane- | | | | | | | MA |
| | Treated | | | | | | | |
| Tiger | Polyester | | | | | | | |
| Drylac | crosslinked | | | | | | | |
| Series 49 | with TGIC | | | | | | | |
| | (triglycidyl | | | | | | | |
| | isocyanurate) | | | | | | | |
| SoftSand ® | Rubber | | | 90, 180, | Various | | SoftPoint | Copley, OH |
| | based | | | or 300 | colors | | Industries | |

^{a}GPS—general purpose series
^{b}ceramic microspheres
^{c}hollow spheres
^{d}modified polyethylene resins
^{e}microglass milled E-glass filaments

In addition to the chemical nature of the first-particles, other variables may be considered in the selection of first-particles. These variables include, but are not limited to, the effect the first-particles are expected to have on surfaces, their hardness, the expected resistance of the first-particles to the environment in which the coating will be employed, and the environment the first-particles must endure in the coating process including resistance to pressure and/or heat (e.g., their melting temperature, and rate of softening), and where the first-particles can melt, the miscibility of the melted particles with the material being molded or formed. For example, where a first-particle is applied to a mold or die in which a plastic object is to be prepared, the first-particle needs to be compatible with the plastic used in the injection molding or forming process, including compatibility of melting points and the ability of the first-particle to be incorporated into the formed plastic article (e.g., bind or bond to the molded or formed plastic).

In some embodiments, where incorporation of first-particles is intended to increase surface roughness (e.g., as measured by Ra or Rz), or resist the loss of HP/OP behavior, relative to surfaces prepared in the absence of first-particles, the melting point of the first-particles should be above the melting point of the material to be molded or formed. The melting point can be from about the highest temperature the particles will experience in the molding or forming process to a temperature significantly higher than the temperature to which the particles will be subjected (including the temperature required to cure the molded or formed material). In one set of embodiments the first particles have melting points at least 10°, at least 20°, at least 30°, at least 40°, at least 50°, or at least 75° C. higher than the material to be molded or formed.

In some embodiments, the melting point of the first-particles is lower than the highest temperature to which the first-particles are subjected during a molding or forming process (including curing or annealing). Where the first-particles have a melting point lower than the highest temperature employed in the molding or forming process they may be deformed or melted in the process. When melted, the composition comprising the first-particles may coat the material that is being formed or molded, thereby entrapping, anchoring or affixing any remaining first particles and second-particles on the surface of the material being formed. Alternatively, where the melted first-particles are miscible with the material being molded or formed, the composition may mix with at least the portion of the material contacting the mold or forming the surface where the first-particles have been deposited. Under such circumstances any remaining first particles and second-particles may be entrapped, anchored, or affixed to the surface of the formed article in a composition which is a mixture of the material being formed and the first-particles. In one embodiment, the first-particles are of the same composition as the material being molded or formed, in which case the particles may not melt, may deform, or may melt, depending on a number of factors including the temperature, pressure and heat of fusion of the material being molded or formed.

In an embodiment, first-particles have an average size in a range selected from: greater than about 1 micron (μm) to about 50 μm; about 5 μm to about 50 μm; about 1 μm to about 5 μm; about 2 μm to about 10 μm; about 10 μm to about 100 μm; about 10 μm to about 200 μm; about 20 μm to about 200 μm; about 30 μm to about 100 μm; about 30 μm to about 200 μm; about 50 μm to about 100 μm; about 50 μm to about 200 μm; about 75 μm to about 150 μm; about 75 μm to about 200 μm; about 100 μm to about 225 μm; about 125 μm to about 225 μm; or about 100 μm to about 250 μm.

In another embodiment, first-particles have an average size in a range selected from: about 30 μm to about 225 μm; about 30 μm to about 50 μm; about 30 μm to about 100 μm; about 30 μm to about 200 μm; about 50 μm to about 100 μm; about 50 μm to about 200 μm; about 75 μm to about 150 μm; about 75 μm to about 200 μm; about 100 μm to about 225 μm; about 125 μm to about 225 μm or about 100 μm to about 250 μm.

### 4.0 Second-Particles

4.1 Second-Particle Size and Composition

The processes disclosed herein employ second-particles (e.g., nanoparticles), which are particles that bear, or are associated with, hydrophobic and possibly also oleophobic compounds or moieties (i.e., moieties that are covalently or non-covalently bound). The hydrophobic compounds or moieties can be introduced by treating the particles to include compounds, groups, or moieties such as siloxanes, fluorinated hydrocarbons (e.g., partly or fully fluorinated hydrocarbons) or nonfluorinated hydrocarbons. In an embodiment, second-particles suitable for the preparation of HP/OP surfaces have a size from about 1 nano meter (nm) to about 25 μm and are capable of binding covalently to one or more chemical moieties (groups or components) that provide the second-particles, and the coatings into which they are incorporated, hydrophobic behavior, and when selected to include fluoroalkyl groups, hydrophobic behavior and oleophobic behavior.

In one embodiment the second-particles have a surface area over 100, 150, 200, 250, or 300 square meters per gram (m²/g) of particulate or in the range of 100-150, 150-200, 200-250, 250-300, 100-200, 200-300, or 100-300 m²/g. In another embodiment, where the particles are fumed silica, the surface area can be about or greater than 150, 175, 200, 225 or 250 m²/g.

Second-particles having a wide variety of compositions may be employed in the durable HP/OP coatings described and employed herein. In some embodiments the second-particles are particles comprising ceramics, metal oxides (e.g., aluminum oxides such as alumina, zinc oxides, nickel oxides, zirconium oxides, iron oxides, or titanium dioxides), or oxides of metalloids (e.g., oxides of B, Si, Sb, Te and Ge), such as a glass, silica (e.g., fumed silica), silicates, aluminosilicates, or particles comprising combinations thereof. In another embodiment the second-particles are ceramics or metals oxide particles. In another embodiment the second-particles are selected from silica, alumina, titanium dioxide (TiO₂), iron oxide, and mixtures of any two, three or all four thereof.

In some embodiments, the second-particles may have an average size in a range selected from: about 1 nm to about 25 μm or more. Included within this broad range are embodiments in which the second-particles have an average size in a range selected from: about 1 nm to about 10 nm, from about 10 nm to about 25 nm, from about 25 nm to about 50 nm, from about 50 nm to about 100 nm, from about 100 nm to about 250 nm, from about 250 nm to about 500 nm, from about 500 nm to about 750 nm, from about 750 nm to about 1 μm, from about 1 μm to about 5 μm, from about 5 μm to about 10 μm, from about 10 μm to about 15 μm, from about 15 μm to about 20 μm, from about 20 μm to about 25 μm, from about 1 nm to about 50 nm, from 1 nm to about 100 nm, from about 2 nm to about 200 nm, from about 10 nm to about 200 nm, from about 20 nm to about 400 nm, from about 10 nm to about 500 nm; from about 40 nm to about 800 nm, from about 100 nm to about 1 μm, from about 200 nm to about 1.5 μm, from about 500 nm to about 2 μm, from about 500 nm to about 2.5 μm, from about 1 μm to about 10 μm, from about 2 μm to about 20 μm, from about 2.5 μm to about 25 μm, from about 500 nm to about 25 μm, from about 400 nm to about 20 μm, from about 100 nm to about 15 μm, from about 1 nm to about 400 nm, from about 1 nm to about 500 nm, from about 2 nm to about 120 nm, from about 5 nm to about 100 nm, from about 5 nm to about 200 nm; from about 5 nm to about 400 nm; about 10 nm to about 300 nm; or from about 20 nm to about 400 nm.

In the above-mentioned embodiments, the lower size of second-particles may be limited to particles greater than about 20 nm, about 25 nm, about 30 nm, about 35 nm, about 40 nm, about 45 nm, about 50 nm, or about 60 nm; and the upper size of second-particles may be limited to particles less than about 20 μm, about 10 μm, about 5 μm, about 1 μm, about 0.8 μm, about 0.6 μm, about 0.5 μm, about 0.4 μm, about 0.3 μm, about 0.2 μm, or about 100 nm.

Any combination of particle size, particle composition, surface area, percent composition in the coatings recited herein may be employed in preparing HP/OP surfaces. In one embodiment, limitations on the upper and lower size of second-particles are used alone or in combination with any of the above-recited particle compositions, surface area, percent composition in the coatings, and the like.

In some embodiments, the processes described herein may employ first-particles and second-particles in any of the above-mentioned ranges subject to either the proviso that the coatings do not contain only particles (e.g., first or second-particles) with a size of 25 μm or less, or the proviso that the coatings do not contain more than an insubstantial amount of second-particles with a size of 25 μm or less (recognizing that separation processes for particles greater than 25 μm may ultimately provide an unintended, insubstantial amount of particles that are 25 μm or less). An insubstantial amount of particles is less than 3% by weight or number of those particles, but it can also be less than 0.5%, 1%, or 2% wherever recited.

In other embodiments, second-particles have an average size greater than 30 μm and less than 250 μm, and coatings comprising those particles do not contain more than insubstantial amounts of particles (e.g., first and second-particles) with a size of 30 μm or less. In yet other embodiments, the coatings do not contain only particles (e.g., first and second-particles) with a size of 40 μm or less, or particles with a size of 40 μm or less in substantial amounts. In addition, in still other embodiments, the coatings do not contain only particles (e.g., first and second-particles) with a size of 50 μm or less, or particles with a size of 50 μm or less in substantial amounts.

In other embodiments, such as where the second-particles are prepared by fuming (e.g., fumed silica or fumed zinc oxide), the second-particles may have an average size in a range selected from about 1 nm to about 50 nm; about 1 nm to about 100 nm; about 1 nm to about 400 nm; about 1 nm to about 500 nm; about 2 nm to about 120 nm; about 5 nm to about 100 nm; about 5 nm to about 200 nm; about 25 nm to about 100 nm; about 30 nm to about 200 nm; about 5 nm to about 400 nm; about 10 nm to about 300 nm; about 20 nm to about 400 nm; or about 50 nm to about 400 nm.

In one embodiment, second-particles comprise silica, silicates, alumina (e.g., Al₂O₃), titanium oxide, or zinc oxide that are treated with one or more silanizing agents, e.g., compounds of formula I. In other embodiments, second-particles are comprised of silica, silicates, alumina (e.g., Al₂O₃), titanium oxide, or zinc oxide that are treated with a siloxane. In another embodiment, the second-particles are comprised of silica, silicates, glass, alumina (e.g., Al₂O₃), titanium oxide, or zinc oxide, treated with a silanizing agent, a siloxane or a silazane. In another embodiment, the second-particles are comprised of a fumed metal or metalloid (e.g., particles of fumed silica or fumed zinc oxide).

As indicated above, second-particles bear one or more moieties, group, components, or compounds that impart HP/OP properties to the particles. Those groups or components are introduced either prior to incorporation of the second-particles into the coating-compositions that will be applied to molding or forming equipment (or the material to be molded or formed). Alternatively, where precursors of second particles are used in the molding or forming process those groups are added after the object is molded or formed. In some embodiments, moieties providing HP/OP properties to the second-particles result from the interaction of a silanizing agent, a silane, a siloxane or a silazane, with precursors of second-particles.

In embodiments where a silanizing agent is employed to introduce moieties providing HP/OP properties, the silanizing agent maybe a compounds of the formula (I):

R₄₋ₙSi—Xₙ (I)

where n is an integer from 1-3;
each R is independently selected from:
(i) alkyl or cycloalkyl group optionally substituted with one or more fluorine atoms,
(ii) C₁ to C₂₀ alkyl optionally substituted with one or more substituents independently selected from fluorine atoms and C₆₋₁₄ aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
(iii) C_{6 to 20} alkyl ether optionally substituted with one or more substituents independently selected from fluorine and C_{6 to 14} aryl groups, which aryl groups are optionally substituted with one or more independently selected halo, C_{1 to 10} alkyl, C_{1 to 10} haloalkyl, C_{1 to 10} alkoxy, or C_{1 to 10} haloalkoxy substituents,
(iv) C_{6 to 14} aryl, optionally substituted with one or more substituents independently selected from halo or alkoxy, and haloalkoxy substituents;
(v) C_{4 to 20} alkenyl or C_{4 to 20} alkynyl, optionally substituted with one or more substituents independently selected from halo, alkoxy, or haloalkoxy; and
(vi) —Z—((CF₂)_{q}(CF₃))ᵣ, wherein Z is a C_{1 to 12} divalent alkane radical or a C₂₋₁₂ divalent alkene or alkyne radical, q is an integer from 1 to 12, and r is an integer from 1-4;
each X is an independently selected —H, —Cl, —I, —Br, —OH, —OR², —NHR³, or —N(R³)₂ group;
each R² is an independently selected C_{1 to 4} alkyl or haloalkyl group; and
each R³ is an independently selected H, C_{1 to 4} alkyl, or haloalkyl group.

In some embodiments, R is an alkyl or fluoroalkyl group having from 6 to 20 carbon atoms.

In other embodiments, R is an alkyl or fluoroalkyl group having from 8 to 20 carbon atoms.

In other embodiments, R is an alkyl or fluoroalkyl group having from 10 to 20 carbon atoms.

In other embodiments, R is an alkyl or fluoroalkyl group having from 6 to 20 carbon atoms and n is 3.

In other embodiments, R is an alkyl or fluoroalkyl group having from 8 to 20 carbon atoms and n is 3.

In other embodiments, R is an alkyl or fluoroalkyl group having from 10 to 20 carbon atoms and n is 3.

In other embodiments, R has the form —Z—((CF₂)_{q}(CF₃))ᵣ, wherein Z is a C_{1 to 12} divalent alkane radical or a C_{2 to 12} divalent alkene or alkyne radical, q is an integer from 1 to 12, and r is an integer from 1 to 4.

In any of the previously mentioned embodiments of compounds of formula (I), the value of n may be varied such that 1, 2 or 3 independently selected terminal functionalities are present in compounds of formula (I). Thus, in some embodiments, n is 3. In other embodiments, n is 2, and in still other embodiments, n is 1.

In any of the previously mentioned embodiments of compounds of formula (I), all halogen atoms present in any one or more R groups may be fluorine.

In any of the previously mentioned embodiments of compounds of formula (I), X may be independently selected from H, Cl, —OR², —NHR³, —N(R³)₂, or combinations thereof. In other embodiments, X may be selected from Cl, —OR², —NHR³, —N(R³)₂, or combinations thereof. In still other embodiments, X may be selected from, —Cl, —NHR³, —N(R³)₂ or combinations thereof.

Any second particles described herein (and articles prepared using such particles) may be prepared with one, two, three, four or more compounds of formula (I) employed alone or in combination to modify the second-particles. For example, the same or different compounds of formula (I) may be employed to modify second particles.

The use of silanizing agents of formula (I) to modify second-particles will introduce one or more R₃₋ₙXₙSi— groups (e.g., R₃Si—, R₂X₁Si—, or RX₂Si— groups) where R and X are as defined for a compound of formula (I). The value of n is 0, 1, or 2, due to the displacement of at least one “X” substituent and formation of at least one bond to the second-particles. The bond is indicated by a dash “—” (e.g., R₃Si—, R₂X₁Si—, or RX₂Si— groups). More than one X group may be displaced and more than one bond to the second particles can occur.

Exemplary reagents that can be employed to prepare second-particles with HP/OP properties include silanizing agents such as those that are commercially available from Gelest, Inc., Morrisville, Pa. Such silanizing agents include, but are not limited to, the following compounds, which are identified by their chemical name followed by the commercial supplier reference number (e.g., their Gelest reference in parentheses): (tridecafluoro-1,1,2,2-tetrahydrooctyl)silane (SIT8173.0); (tridecafluoro-1,1,2,2-tetrahydrooctyl)trichlorosilane (SIT8174.0); (tridecafluoro-1,1,2,2-tetrahydrooctyl)triethoxysilane (SIT8175.0); (tridecafluoro-1,1,2,2-tetrahydrooctyl)trimethoxysilane (SIT8176.0); (heptadecafluoro-1,1,2,2-tetrahydrodecyl)dimethyl(dimethylamino)silane (SIH5840.5); (heptadecafluoro-1,1,2,2-tetrahydrodecyl)tris(dimethylamino)silane (SIH5841.7); n-octadecyltrimethoxysilane (SIO6645.0); n-octyltriethoxysilane (SIO6715.0); and 3,3,4,4,5,5,6,6,6-nonafluorohexyldimethyl(dimethylamino)silane (SIN6597.4).

Another group of reagents that can be employed to prepare second-particles with HP/OP properties include tridecafluoro-1,1,2,2-tetrahydrooctyl)trichlorosi lane; (tridecafluoro-1,1,2,2-tetrahydrooctyl)triethoxysilane; nonafluorohexyldimethylchlorosilane; (tridecafluoro-1,1,2,2-tetrahydrooctyl)trimethoxysilane; 3,3,4,4,5,5,6,6,6-nonafluorohexyldimethyl(dimethylamino)-silane; nonafluorohexylmethyldichlorosilane; nonafluorohexyltrichlorosilane; nonafluorohexyltriethoxysilane; and nonafluorohexyltrimethoxysilane. In one embodiment, the coating compositions set forth herein comprise silica second-particles treated with nonafluorohexyltrichlorosilane.

In addition to the silanizing agents recited above, a variety of other silanizing agents can be used to alter the properties of second-particles and to provide HP/OP properties. In some embodiments, second-particles may be treated with an agent selected from dimethyldichlorosilane, hexamethyldisilazane, octyltrimethoxysilane, or tridecafluoro-1,1,2,2-tetrahydrooctyl trichlorosilane. In such embodiments, the second-particles may be silica. Silica second-particles treated with such agents may have an average size in a range selected from about 1 nm to about 50 nm, from about 1 nm to about 100 nm, from about 1 nm to about 400 nm, from about 1 nm to about 500 nm, from about 2 nm to about 120 nm, from about 5 nm to about 150 nm, from about 5 nm to about 400 nm, from about 10 nm to about 300 nm, from about 20 nm to about 400 nm, or from about 50 nm to about 250 nm.

Other agents can be used to modify second-particles, including, but not limited to, one or more of: polydimethylsiloxane, gamma-aminopropyltriethoxysilane, Dynasylan® A (tetraethylorthosilicate), hexamethyldisilazane, and Dynasylan® F 8263 (fluoroalkylsilane), any one or more of which may be used alone or in combination with the silanizing agent recited herein.

Two attributes of silanizing agents that may be considered for the purposes of their reaction with second-particles and the introduction of hydrophobic or oleophobic moieties are the leaving group (e.g., X groups of compounds of formula (I)) and the terminal functionality (e.g., R groups of compounds of formula (I)). A silanizing agent's leaving group(s) can determine the reactivity of the agent with the first or second-particle(s), or other components of the coating, if applied after a coating has been applied. Where the first or second-particles are a silicate or silica (e.g., fumed silica) the leaving group can be displaced to form Si—O—Si bonds. Leaving group effectiveness is ranked in the decreasing order as chloro>methoxy>hydro (H)>ethoxy (measured as trichloro>trimethoxy>trihydro>triethoxy). This ranking of the leaving groups is consistent with their bond dissociation energy. The terminal functionality determines the level of hydrophobic behavior that results from application of the silane to the surface.

4.2 Some Sources of Second-Particles

Second-particles such as those comprising fumed silica may be purchased from a variety of suppliers, including but not limited to Cabot Corp., Billerica, Mass. (e.g., Nanogel TLD201, CAB-O-SIL® TS-720 (silica, pretreated with polydimethyl-siloxane), and M5 (untreated silica)) and Evonik Industries, Essen, Germany (e.g., ACEMATT® silica such as untreated HK400, AEROXIDE® silica, AEROXIDE® TiO₂ titanium dioxide, and AEROXIDE® Alu alumina).

Some commercially available second-particles are set forth in Table 3 along with their surface treatment (e.g., by a silanizing agent or polydimethyl siloxane).

TABLE 3
Some commercially available precursors of second-particles and second-particles

| | | | Nominal BET | | |
|---|---|---|---|---|---|
| | | | Surface Area of | | |
| Produce | Surface | Level of | Base Product | Particle Size | Product |
| Name | Treatment | Treatment | (m²/g) | (nm) | Source |
| M-5 | None | None | 200 | — | Cabot |
| Aerosil ® 200 | None | None | 200 | 12 | Evonik |
| Aerosil ® 255 | None | None | 255 | — | Evonik |
| Aerosil ® 300 | None | None | 300 | 7 | Evonik |
| Aerosil ® 380 | None | None | 380 | 7 | Evonik |
| HP-60 | None | None | 200 | — | Cabot |
| PTG | None | None | 200 | — | Cabot |
| H-5 | None | None | 300 | — | Cabot |
| HS-5 | None | None | 325 | — | Cabot |
| EH-5 | None | None | 385 | — | Cabot |
| TS-610 | Dimethyldichlorosilane | Intermediate | 130 | — | Cabot |
| TS-530 | Hexamethyldisilazane | High | 320 | — | Cabot |
| TS-382 | Octyltrimethoxysilane | High | 200 | — | Cabot |
| TS-720 | Polydimethylsiloxane | High | 200 | — | Cabot |
| Aerosil ® | Polydimethylsiloxane | — | 100 | 14 | Evonik |
| R202 | | | | | |
| Aerosil ® | Hexamethyldisilaze | — | 125-175 | — | Evonik |
| R504 | (HMDS) and | | | | |
| | aminosilane | | | | |
| Aerosil ® | HMDS based on | — | 220 | — | Evonik |
| R812S | Aerosil ® 300 | | | | |

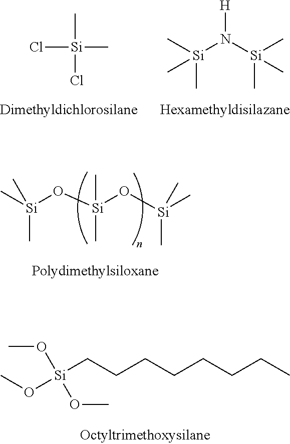

As purchased, the particles may be untreated (i.e., they are precursors of second particles such as M5 silica) and may not possess any HP/OP properties. As discussed herein, such untreated particles can be used in the molding and forming processes and subsequently treated to covalently attach one or more groups or moieties to the particles that give them HP/OP properties, for example, by treatment with any one or more of the silanizing agents discussed above.

4.3 Coating Compositions Comprising Second-Particles

Coating compositions for applying second-particles (or untreated precursors of second-particles), and first-particles if present, comprise the particles and may optionally comprise a solvent (liquid) and/or gas to apply/disperse the particles on the molding or forming equipment (e.g., the mold, dies etc.) or the materials to be molded or formed. Where the coating composition is provided in a pressurized container (e.g., an aerosol spray can) the materials used to disperse particles may be a liquid under the pressure in the container and a gas as applied in the molding or forming process (e.g., when applied to the molds or dies at one atmosphere).

Suitable gases include, but are not limited to air, nitrogen, carbon dioxide, inert gases such as helium, or argon, and low molecular weight hydrocarbons that may or may not be halogenated (e.g., alkanes such as methane, ethane, propane, butane, or alkenes such as ethylene, propene etc.).

Suitable liquids/solvents include, but are not limited to: hydrocarbons and halogenated hydrocarbons (e.g., pentane, hexane, cyclohexane, petroleum ether, methyl-cyclohexane, dichloromethane, 1,1,1,-trichloroethane), ethers (e.g., diethyl ether and methyl ethyl ether) alcohols (e.g., methanol, ethanol, or propanol), ketones (e.g., acetone, methyl ethyl ketone (MEK), methyl isobutyl ketone (MIKB)), esters (e.g., ethyl acetate, isopropyl acetate, or tertbutyl acetate (t-butyl acetate)), aromatics (e.g., toluene or xylene) or mixtures comprising any two, three, four or more thereof. In an embodiment, the solvents are non-aqueous (e.g., they contain less than 10%, 5%, 4%, 3%, 2%, 1%, or 0.5% of water by weight or they contain only insubstantial amounts of water (less than 0.5% by weight).

In one embodiment the solvent is a rapidly evaporating liquid with a boiling point less than 40° C. (e.g., pentane), 60° C. (e.g., acetone, petroleum ether), 70° C. (e.g., methanol,), or 80° C. (e.g., hexane, ethanol, ethyl acetate) at one atmosphere.

### 5.0 Molding and Forming

5.1 Molds and Pressing, Stamping and Rolling Equipment and their Surfaces

Molding and or forming equipment used in the processes described herein may have the surfaces that contact the materials to be molded or formed that are roughened, textured, or patterned so as to impart a suitable roughness or texture to the material and article formed. First-particles also may be utilized to impart roughness to the surface alone or in combination with roughened, patterned or textured molding or forming equipment. Imparting a roughness to the material can increase the durability of the HP/OP performance and AI performance of the surfaces relative to surfaces that are not roughened, textured, or patterned.

In one embodiment, one or more surfaces of the molding or forming equipment that contact the material to be molded or formed are laser etched or blasted to roughen the surface of a mold, die, press etc. Blasting of molding or forming equipment surfaces, to impart a texture to the surfaces that will contact the materials to be molded or formed can be accomplished with sand or a harder material such as a ceramic.

The surface texture of the molded or formed object may be assessed using the arithmetical mean roughness (Ra) as a measure of the surface texture of both the molded or formed object and the equipment that imparts the texture. In an embodiment, the surface of the object has arithmetical mean roughness (Ra) in a range selected from: about 0.2 microns to about 20 microns; from about 0.3 microns to about 18 microns; from about 0.2 microns to about 8 microns; from about 8 microns to about 20 microns; or from about 0.5 microns to about 15 microns. In another embodiment, the surface of an object that is molded or formed has a Ra from 1 to 20, 1-10, 10-20, 1-5, 5-10, 10-15, 15-20 or 20-30 microns. Alternatively, the Ra may be greater than 2, 4, 6, 8, 10, 12, or 14 microns and less than 16, 18, 20, 22, 24, 26 28, or 30 microns.

In another embodiment, the surface of an object that is molded or formed has a ten point mean roughness (Rz) in a range selected from: about 1 micron to about 90 microns; from about 2 microns to about 80 microns; from about 3 microns to about 70 microns; from about 1 micron to about 40 microns; from about 40 microns to about 80 microns; from about 10 microns to about 65 microns; or from about 20 microns to about 60 microns.

5.2 Molding Processes

A variety of molding or casting processes may be employed to introduce material that is in a flowable state into a mold that has been treated with a coating composition comprising second-particles or precursors of second-particles, and optionally comprising first-particles. In one embodiment the flowable material is allowed to enter the mold by gravity (e.g., poured) or is driven into the mold (e.g., via a spur) using an injection process (injection molding). Alternatively, other casting methods including, but not limited to, spin casting, centrifuge casting (centrifugal casting) and blow molding may be employed.

In one embodiment, the molding process described herein includes a method of preparing HP/OP areas on all or part of the surface of a molded object (article) comprising:
a) applying a coating composition comprising second-particles and optionally comprising first-particles to all or part of the surface of a mold that will shape some or all of the object, thereby forming a coated mold surface; and
b) introducing the material to be molded into the mold (or die) in a flowable state, thereby contacting at least a portion of said material with said coated mold surface, by which at least a portion of the second particles are incorporated into the molded object's surface.

In another embodiment, the molding process described herein includes a method of preparing HP/OP areas on all or part of the surface of the molded object comprising:
a) applying a coating composition comprising precursors of second-particles and optionally comprising first-particles to all or part of the surface of a mold that will shape some or all of the object, thereby forming a coated mold surface;
b) introducing the material to be molded into the mold in a flowable state, thereby contacting at least a portion of said material with said coated mold surface, by which at least a portion of the precursors of second particles are incorporated into the molded object's surface; and
c) applying a silanizing agent or a siloxane to at least a portion of said material that was contacted with the coated mold surface to change some or all of the precursors of second-particles into second-particles and render the surface HP/OP.

A number of variations of the above-described molding process are possible. In variations of such molding embodiments the first-particles, if present, are stable at the temperature at which the material to be molded achieves the flowable state employed in the molding process. In another variation of the embodiments described above, the process employs precursors of second-particles that are stable at the temperature at which the material to be molded achieves a flowable state used in the molding process. As the precursors particles do not bear moieties, groups or compounds that render the particle HP/OP, they are converted to second particles after the mold article is removed from the mold and cooled sufficiently to permit treatment with suitable agents (e.g., silanizing agents) that can convert some or all of the precursors to second particles. Such variations of the molding process described are useful where the molding process is conducted under conditions that can damage second-particles and/or first-particles such as by exposing the particles to excessive force (e.g., pressure) or elevated temperatures for an extended period of time.

5.3 Forming Processes

A variety of forming processes may be employed to prepare objects or articles that have HP/OP properties over all or part of their surfaces including, but not limited to, stamping, pressing, embossing, rolling.

In one embodiment a forming process for preparing HP/OP surfaces comprises: a) applying a coating composition comprising second-particles and optionally comprising first-particles to all or part of the surface of either: (i) the forming equipment's surfaces that will contact the material (e.g., dies, plates rollers, etc.) to be formed into all or part of the object, or (ii) the surface of the material to be formed into all or part of the object; and b) forming all or part of the object by contacting material to be formed with the forming equipment's surfaces.

In another embodiment, a forming processes for preparing HP/OP surfaces on all or part of an object or article comprises:

a) applying a coating composition comprising second-particles and optionally comprising first-particles to all or part of the surface of either:
(i) a pressing, rolling or stamping surface that will contact the material to be formed into all or part of the object, or
(ii) a material to be pressed, rolled or stamped into all or part of the object; and

b) pressing, rolling or stamping the material to form all or part of the object.

5.4 Molding and Forming Processes used in Combination

Where it is desirable to prepare objects having internal hydrophobic surfaces it is possible to use the molding and forming processes described herein to prepare such surfaces. In one embodiment, materials may be molded, such as by extrusion molding and subsequently molded or formed further. Accordingly, with processes such as extrusion molding an extruded plastic, polymer, resin, or metal article may be prepared and subject to the application of a coating composition comprising second particles on an interior and/or exterior surface, and subject to further molding or forming as part of a continuous extrusion process or in a subsequent step.

In one embodiment, the interior surface of tubing or piping is contacted with a coating composition comprising second particles (e.g., by spraying, pouring, or aerosolizing the coating composition inside the pipe). The interior surface is passed over, or a mandrel is passed through, the tube to form the interior surface and incorporate the second particles into the interior wall of the tube or pipe, thereby rendering it hydrophobic. Where it is deemed desirable, the mandrel and/or the tubing can be heated. In addition to the foregoing, where it is deemed desirable, a texture can be imparted to the interior of the pipe wall by the mandrel. For example, the mandrel may have veining or be prepared so as to form rifling on the interior pipe or tube wall generally on the order of 3, 5, 10, 15, 20, or 30 microns deep. The use of the mandrel is likely to slightly increase the interior pipe diameter, and possibly the exterior pipe diameter as well.

In another embodiment, the interior wall of piping or tubing may be made hydrophobic during the process of extrusion molding. In such a process, the coating composition comprising second particles is applied to the interior surface of an initially extruded tube. Following the application of the coating composition the second particles are incorporated into the inner wall of the tube as it passes over a mandrel downstream of the area where the coating composition is applied. As discussed above, where it is deemed desirable, the mandrel and/or the tubing can be heated as the tube passes over the mandrel. And as discussed above, where it is deemed desirable, a texture can be imparted to the interior of the pipe wall by the mandrel.

5.5 Molding and Forming Processes Variations, Embodiments and Conditions

Depending upon a number of factors including, but not limited to, the material to be formed, the type of moiety, group, or compound (alkyl or fluoroalkyl silane or siloxane) bound to the second-particle, and the time it takes to conduct molding or forming, a broad range of temperatures from 0 to about 750° C. may typically be employed in the molding and forming process. In some embodiments, molding or forming may be conducted using materials in a temperature range selected from 0-100, 100-200, 200-300, 300-400, 400-500, 500-600, 600-700, 0-200, 100-300, 200-400, 300-500, 400-600, 500-700, 0-50, 50-100, 100-150, 150-200, 250-300, 300-350, 350-400, 400-450, 500-550, 550-600, 600-650, 650-700, or 700-750° C. Similarly, molding and forming may include treatments conducted pre-, post-, or concurrent with molding or forming, and/or the use of heated molds, dies, plates, stamping or pressing equipment that are typically kept in the above-mentioned temperature ranges. Accordingly, depending on the materials being processed, it may be advantageous to control the temperature of the portions of the molding and forming equipment that will come into contact with the materials to be molded or formed, particularly where flowable materials such as thermoplastics are being molded or formed.

Molding and forming processes need not be conducted under conditions of constant temperature. In some instances it may be desirable to increase or decrease the temperature of the material being molded or formed during the process. Although, molding and forming processes that use materials made flowable due to heating (e.g., injection molding of thermoplastics) will, by their nature, involve a decrease in the temperature of the molded or formed material prior to the release of the solid article, other molding and forming operations may advantageously employ variations in the temperature. For example, in one embodiment, molding and forming processes employing thermoset plastics may utilize increases in temperature for at least a portion of the process to set and or cure the objects (articles) being molded.

Where the physical/chemical conditions for molding or forming are incompatible with the chemical or physical stability of second-particles (e.g., temperature), precursors of second-particles that can be converted to second-particles by post-molding/forming treatment(s) may be employed. In one embodiment, molding or forming is conducted under conditions (e.g., time, temperature, etc.) under which second-particles bearing the desired hydrophobic moieties (e.g., silane or siloxane moieties) are chemically or physically unstable. Under such circumstances, precursors of second-particles, such as fumed silica, that can be converted into HP/OP second-particles by post-molding treatment can be employed. After molding or forming with precursors particles that can be converted to second-particles, the article may be treated with an agent (e.g., silanizing agent or siloxane) to convert the precursor particles (e.g., fumed silica) embedded in the articles surface into second-particles, thereby rendering the surface of the molded object HP/OP. Thus, for example, a coating composition comprising silica particles of a suitable size (e.g., a fumed silica), which are precursors of second particles, may be employed and after the article is released from a mold or has been formed by stamping or pressing etc., some or all of the precursor particles may be converted into second-particles by treatment with silanizing agents, siloxanes, or the like. Accordingly, where precursors of second-particles are employed in place of second-particles the molding and forming methods described above further comprises a step of treating all or part of the formed object with a composition that comprises agents that convert some or all of the precursors of second-particles into second-particles (e.g., a step of applying a composition comprising a silanizing agent or a siloxane to at least a portion of said object that was formed) and render all or part of the surface HP/OP.

In another embodiment, the temperature of a surface material into which the particles (e.g., first or second-particles) are to be applied may be controlled prior to the introduction of the particles. Surface heating may be advantageously applied where the material softens when heated, permitting incorporation of particles. By heating only the surface of the material it may be possible not only to more readily introduce the particles, but also to minimize their exposure to high temperatures, because the surface will cool faster if the bulk of the material is not heated.

Heated molding and forming equipment can be applied to a material that becomes flowable when heated. Such equipment acts like a stamp to incorporate particles into the surface of the material and simultaneously introduce the desired texture or pattern to the material.

Objects prepared by molding or forming may benefit from curing or annealing at temperatures higher than room temperature and below their melting point. Annealing may have multiple effects, including the relaxation of strain in the molded or formed object and the alteration of surface roughness. In addition to curing, objects may be given a rapid surface heating that will soften or melt only a fraction (e.g., about 1, 10, 25, 50, 75, 100, 200 or 250 microns) of the outer surface to alter the disposition of first and/or second-particles and/or to change the roughness (Ra or Rz) of the surface. Rapid surface heating may be accomplished by any suitable means such as exposure to infrared heat sources, visible light, microwaves, a flame etc.

Where it is desired to incorporate first-particles in the surface of the material being molded or formed, the first-particles may be applied, prior to, concurrent with, or subsequent to the second-particles. Accordingly, it is possible to employ multiple molding or forming steps to incorporate first and second particles. In one embodiment the multiple steps are performed sequentially with no intervening steps, and in another embodiment the steps may be performed with intervening steps that may include, but are not limited to, milling, shaping, or annealing. First-particles may be applied over areas that are coextensive with the areas treated with second-particles, or, alternatively, areas that are not coextensive with the areas treated with second-particles (e.g., areas that encompass, overlap with, or are less than the areas treated with second-particles).

In one embodiment the forming process comprises forming the material by applying a force from about 690 Pascals (Pa) (about 0.1 lbs per inch square) to about 140 MPa (about 20,000 lbs per inch square). Alternatively the force may be from about 3,500 Pa to about 10,000 Pa, from about 10,000 Pa to about 100,000 Pa, from about 100,000 Pa to about 500,000 Pa, from about 400,000 Pa to about 1 MPa, from about 1 MPa to about 10 MPa, from about 10 MPa to about 20 MPa, from about 20 MPa to about 40 MPa, from about 40 MPa to about 60 MPa, from about 60 MPa to about 80 MPa, from about 80 MPa to about 100 MPa, from about 100 MPa to about 120 MPa, or from about 110 MPa to about 140 MPa.

### 6.0 Molded and Formed Objects and Surfaces

A large variety of objects can be prepared using the methods described herein, including consumer and industrial products or parts thereof.

In one embodiment the objects are consumer products (or parts thereof) including, but not limited to: Toys—trucks, cars, bikes, scooters, playground equipment (swings, slides, teeter-totters), water toys, toys for use in bathtubs; Cleaning products—toilet brushes, toilet plungers, mops, dust mops; Furniture—outdoor lawn furniture, park furniture; Pet products—litter boxes, litter scoopers, drinking and food bowls, collars; Consumer electronics—cell phones, watches, smart phones, tablets (similar to iPads), cameras, video games, GPS devices, communication radios, MP3 and electronic music players; Home and garden tools and/or farm equipment—shovels, spades, rakes; Shoes—plastic shoes, sandals, rubber shoes, shoes similar to Crocs; Sporting goods and exercise equipment—skis, athletic shoes, balls, in-line skates, roller skates; Appliances—portions or entire refrigerator plates, freezer liners, parts in washing machines and dryers; Baby products—car seats, potty seats, bibs; Food articles—silverware (made from plastics), cups, plates, bottles (e.g., for beverages, water, liquids, and other foods), and measuring cups; Medical products for applications such as urine measurement and for containing or measuring liquid medication, and many more.

In another embodiment the articles are industrial products (or parts thereof) include, but not limited to: Automotive parts—bumpers, internal plastic parts, engine parts, structural parts, plastic connectors; Protective equipment—helmets; Building products—rain spouts, doors, counters (polymer), flooring, ceilings, wall components or coverings; Laboratory—trays, storage bins, tools, petri dishes, funnels, tubing; Electrical—electrical housings, cables, wire coverings, circuit boards; Medical—catheters, tubing, stents, surgical tools, exam tables, operating room equipment (e.g., tables), dental chairs.

### 7.0 Properties of Molded and Formed Objects and Surfaces

HP/OP behavior can be introduced into various molded and/or formed materials (e.g., polymeric materials such as resins, plastics and paintable coatings, and metals and their alloys) by incorporation of particles bearing chemical compounds or functional groups into at least the surface of the materials in molding and/or forming processes. The materials produced resist the loss of their HP/OP properties due to abrasion, and resist wetting when subject to a shower of water or when submerged. In addition, the materials display resistance to the formation and adhesion of ice and adhesion of ice.

The HP/OP surfaces of plastic, polymer, resin, and metal objects prepared by the molding or forming processes described herein resist the loss of HP/OP performance due to abrasion as measured using substantially planar samples subject to Taber model 503 Abraser testing. Unless indicated otherwise the Abraser is equipped with CS-10 (abrasive) wheels and a 1,000 g load. The instrument is operated at room temperature (18-22° C.) and 95 rpm. The end of superhydrophobic behavior is judged by the failure of more than half of the water droplets applied to the tested surface (typically 20) to run (roll) off when the surface is inclined at 3 degrees from horizontal. The tested surface, although no longer superhydrophobic, may still display hydrophobic behavior at the end of the testing. Plastics, polymers, resins, and metals prepared by the molding and forming methods described herein display greater than 10, 20, 30, 40, or 50 Taber cycles of resistance to the loss of SH behavior provided that the surface or material itself can withstand the abrasion measurement and does not delaminate, buckle or wear away. Where CS0 rubber wheels are used in place of CS10 wheels, the samples can withstand greater than 100, 150, 200 or 250 Taber cycles before a loss in SH behavior is observed with polymer/plastic samples such as polypropylene. Samples tested with CS 39 leather wheels used in place of CS 10 wheels display greater than 10, 20, 30, 40, or 50 Taber cycles of resistance to the loss of SH behavior.

The HP/OP surfaces of plastic, polymer, resin, and metal objects prepared by the molding or forming processes described herein resist the loss of HP/OP performance, that is, becoming wet, when subject to a shower of water for a significant period of time. The time to the loss of SH behavior under a shower of water is measured using a shower applied from a showerhead placed about 244 cm (96 inches) above a substantially planar test surface inclined at 3 degrees from the horizontal. The showerhead having 70 nozzles with a 1 mm diameter orifice arranged in 5 spokes of 5 nozzles and 15 spokes of 3 nozzles about a central point on the circular showerhead. The apparatus delivers a shower of about 6 liters of room temperature (18-22° C.) tap water per minute using about 137900 to about 310275 Pa (about 20 to about 45 psi) over an approximately circular area of about 150 cm in diameter at the level of the test surface. The time to loss of superhydrophobic behavior is determined to be the period of time after which water droplets from the shower begin to stick to the surface (no longer freely run off the surface) of a sample placed in the shower. Plastics, polymers, resins, and metals prepared by the molding and forming methods described herein display greater than about 1, 2, 2.5, 3, 4 or 4.5 hours of resistance to the loss of SH behavior in the above-described shower test.

The HP/OP surfaces of plastic, polymer, resin, and metal objects prepared by the molding or forming processes described herein resist the loss of HP/OP performance, that is, resist becoming wet, when submerged in water (without any agitation) for greater than ½, 1, 2, 3, 4, 5, 6, or even 7 days. Tests on plastic surfaces prepared by the molding and forming methods described herein were stopped at 7 days. Samples that lose their SH behavior after a lengthy period of submersion have been observed to regain the behavior upon drying.

Although not absolutely quantitative, a semi-quantitative glove rub test is a useful indicator of the ability of the surfaces to resist the loss of HP/OP behavior when handled. In the test the thumb of a latex rubber gloved hand is stroked over a substantially planar test surface until the surface no longer shows superhydrophobic behavior. During the test, a sample contact area of approximately 25 mm×25 mm is in contact with the glove and the force applied is approximately 300 g (or about 0.5 g/mm²). The end of superhydrophobic behavior is judged by the failure of more than half of the water droplets applied (typically 20) to the tested surface to run (roll) off when the surface is inclined at 3 degrees from horizontal. Samples can display greater than 20, 40, 60, 80, 100, 120, or 140 glove rubs before losing SH behavior. The number of glove rubs to the loss of SH behavior correlates with the time to the loss of SH behavior in the shower test described above. For each glove rub to the loss of SH behavior a sample typically takes 2 to 2.2 minutes in the shower to lose its SH behavior (i.e., a ratio of 1:2 to about 1:2.2).

Loss of superhydrophobic behavior, particularly with fabrics, can also be measure by subjecting a surface to the action of a cylindrical rubber finger fitted with a 14/20 white rubber septum (outside diameter of 13 mm and inside diameter of 7 mm with a contact surface area of 94 mm²). The finger is rubbed across the surface using a motorized American Association of Textile Chemists and Colorists (AATCC) CM-5 Crockmeter applying a 9 N (Newton) load. The end of superhydrophobic behavior is judged by the failure of more than half of the water droplets applied to the tested surface (typically 20 droplets) to run (roll) off when the surface is inclined at 3 degrees from horizontal.

The surfaces of objects prepared by the molding and forming processes described herein display resistance to ice formation and/or accretion in dynamic testing, and also prevent ice that forms from adhering to the surface as tightly as it does to control surfaces. Ice that forms on the HP/OP surfaces prepared as described herein can be removed with less force than is required to remove ice from control surfaces that are prepared by essentially the same molding and/or forming processes with the exception that second particles have not been introduced into the control surfaces.

### 8.0 Certain Embodiments

1. A method of preparing hydrophobic (HP)/superhydrophobic (SH) and/or oleophobic (OP), surfaces on all or part of a molded object comprising:

a) applying a coating composition comprising second-particles and optionally comprising first-particles to all or part of the surface of a mold that will shape some or all of the object, thereby forming a coated mold surface; and

b) introducing a material to be molded into the mold in a flowable state, thereby contacting at least a portion of said material with said coated mold surface.

2. A method of preparing hydrophobic (HP)/superhydrophobic (SH) and oleophobic (OP), areas on all or part of the surface of pressed, rolled or stamped objects comprising:

a) applying a coating composition comprising second-particles and optionally comprising first-particles to all or part of the surface of either:

(i) the pressing, rolling or stamping surface that will contact the material to be formed into all or part of said object, or

(ii) the surface of the material to be pressed, rolled or stamped into all or part of said object; and

b) pressing, rolling or stamping the material to form all or part of said object.

3. The method of embodiment 1 or embodiment 2, wherein the mold, or the pressing, rolling or stamping surface is textured by grinding, sandblasting, laser patterning, chemical etching, plasma spraying, or machining.

4. The method of embodiment 3, wherein the coating composition comprises second-particles suspended in a solvent.

5. The method of embodiment 4, wherein the second-particle concentration varies from about 1% to about 2% by weight of said coating composition.

6. The method of embodiment 4 or embodiment 5, wherein said solvent, comprises at least 1, 2, 5, 10, 20, 30, 40, 50, 60, 70, 80, 90, or 95% by weight of acetone, hexane, and/or MEK.

7. The method of any preceding embodiment wherein said second-particles have an average size from about 1 nm to about 1 micron.

8. The method of any preceding embodiment, wherein said particles have a surface area from about 50 m2/g to about 500 m2/g.

9. The method of any preceding embodiment, wherein said second-particles are functionalized with one or more independently selected fluorinated silanes, alkyl silanes, silanes of formula I, siloxanes, C1-C4 hydrocarbons, C3-C8 hydrocabons, C5-C10 hydrocabons, C7-C20 hydrocabons, C10-C22 hydrocabons, C12-C24 hydrocabons, alkyl groups, alkyl groups substituted with one or more independently selected cycloalkyl functionalities, fluoroalkyl groups, or fluoroalkyl groups substituted with one or more cycloalkyl or fluorinated cycloalkyl groups.

10. The method of any of embodiments 1-9 wherein said coating composition further comprises first-particles.

11. The method of embodiment 10, wherein said surface of a molded object is formed by injection molding, blow molding, spin casting, or centrifugal casting and said first-particles have a melting point less than, or less than or equal to the melting point of the material to be molded.

12. The method of embodiment 10, wherein said surface of a molded object is formed by injection molding, blow molding, or centrifugal casting, and said first-particles have a melting point greater than, or greater than or equal to the melting point of the material to be molded.

13. The method of any preceding embodiment, wherein said materials comprises: plastic, polyurethane, epoxy, acrylic, metal, or rubber.

14. The method of any preceding embodiment, wherein said material comprises greater than about 5, 10, 20, 30, 40, 50, 70, 80, 90 or 95 percent by weight of any plastics in Table 1 and/or Table 2, or any combination thereof.

15. The method any of any preceding embodiment, wherein said material comprises greater than about 5, 10, 20, 30, 40, 50, 70, 80, 90 or 95 percent by weight of any one or more metallic elements in their metallic state.

16. The method of embodiment 15, wherein said material comprises, aluminum, an aluminum alloy, zinc, a zinc alloy, copper, a copper alloy, silver, a silver alloy, tin, a tin alloy, gold, a gold alloy, tin, a tin alloy, iron, an iron alloy, nickel, a nickel alloy, magnesium, a magnesium alloy, chromium, a chromium alloy, palladium, a palladium alloy, platinum, a platinum alloy, cadmium, or a cadmium alloy.

17. The method of embodiment 15 or embodiment 16, wherein when first-particles, if present, have a hardness greater than that of said material under the conditions where the materials is subject to said pressing, rolling or stamping.

18. The method of embodiment 17, wherein said conditions include heating said materials.

19. The method of any preceding embodiment, wherein said material comprises a one-component or two component polyurethane, epoxy, and/or acrylic.

20. The method of embodiment 19, wherein said one-component or two component polyurethane, epoxy, and/or acrylic is a water-based one-component or two component polyurethane, epoxy, and/or acrylic.

21. The method of embodiment 19, wherein said one-component or two component polyurethane, epoxy, and/or acrylic is a solvent-based one-component or two component polyurethane, epoxy, and/or acrylic.

22. The method of any of embodiments 2-18, wherein said material subject to said pressing, rolling or stamping comprises a non-woven fabric.

23. The method of any preceding embodiment, wherein said first-particles comprise greater than about 2, 5, 10, 20, 30, 40, 50, 70, 80, 90 or 95 percent by weight of Ag.

24. The method of any preceding embodiment, wherein said first-particles comprise a glass to yield reflective properties.

25. An object comprising a surface prepared by the method of any preceding embodiment.

26. The object according to embodiment 25, wherein said surface is comprised of: a plastic, polyurethane, epoxy, acrylic, metal, rubber, or non woven fabrics; and wherein said surface comprises first and second-particles.

27. The object according to embodiment 26, wherein said surface comprises second first or second-particles comprised of an oxide of Si, Ti, Al, Fe.

28. The object according to embodiment 27, wherein said surface comprises second-particles that are treated with a silane.

29. The object of any preceding embodiments 25-28, wherein said object remains hydrophobic and/or oleophobic after any one or more of:
a) 10, 20, 30, 40 or 50 Taber cycles using CS10 wheels and a 1,000 g load at 95 rpm;
b) submersion in water at 40 psi of water pressure for over 7 days; or
c) exposure to a constant shower of water for 4 hours.

30. The method of any one of embodiments 1-24, wherein the surface of the object is rendered both hydrophobic and oleophobic.

31. The method of any one of embodiments 1-24 and 30, wherein the surface of the object is rendered superhydrophobic.

32. The method of embodiments 31, wherein the surface of the object is also rendered superoleophobic.

33. An object according to any of embodiments 25-29, wherein the surface of the object is rendered both hydrophobic and oleophobic.

34. An object according to any of embodiments 25-29 and 33, wherein the surface of the object is rendered superhydrophobic.

35. An object according to embodiment 34, wherein the surface of the object is also rendered superoleophobic.

### 9.0 Examples

### Example 1

### Preparation of Superhydrophobic Polymer Sheets and Coatings by Forming A) Preparation of Superhydrophobic Propylene Sheets Using Sandblasted Metal Plates to Impart Texture

Two aluminum plates (5 inches×5 inches×0.125-inches) are sandblasted to a surface roughness of Ra=7 microns. The sandblasted plates are lightly sprayed with a coating composition comprising acetone in which is suspended 1% w/v of M5 (fumed silica from Cabot, Billerica, Mass.) that is treated with tridecafluoro-1,1,2,2-tetrahydrooctyltrichlorsilane (Gelest, Inc., Morrisville. PA). The treatment with the silane imparts SH and OP properties to the particles.

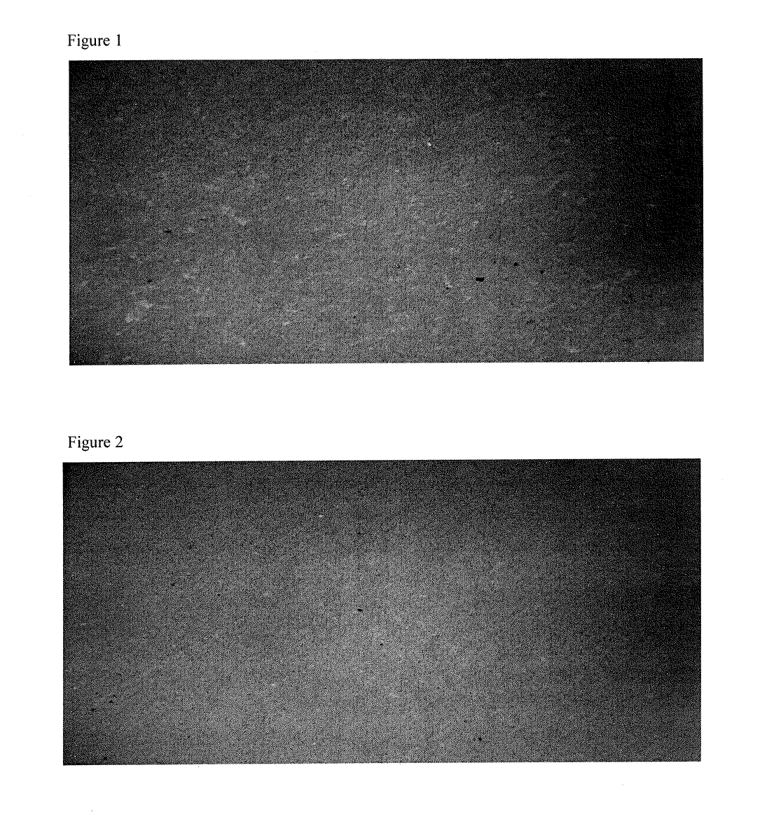

A sheet of polypropylene (PP) measuring about 4 inches×about 4 inches×about 0.125 inches is sandwiched between the plates with the sand blasted surfaces of the plates in contact with the polypropylene. The sandwiched plates are processed at about 280° C. (525° F.) for 3 minutes with about a 2.3 kg (about 5 lb) load applied during the heating cycle. The plates are cooled and the PP plate is removed. A micrograph of the PP plate is shown in FIG. 1.

B) Preparation of Superhydrophobic Propylene Sheets Using Laser Textured Metal Plates to Impart Texture

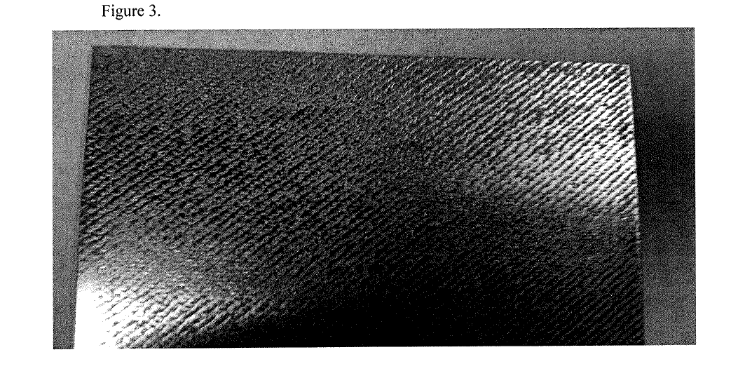

A PP sheet is processed as in part A, above, using aluminum plates that are laser textured to a spacing of 0.02 inches with laser etching. The PP plate has a contact angle over 150° degrees and repels both water and chocolate syrup. A micrograph of the PP plate is shown in FIG. 2.

C) Preparation of Superhydrophobic Polyurethane Coatings Using Fabric to Texture the Coating

An aluminum plate (5 inches×5 inches×0.125-inches) is coated with a two part (two component) polyurethane paint and allowed to cure for 30-40 minutes, at which time it is dry to the touch. A piece of cloth is treated with the coating composition employed in part A, above, except that hexane is used to suspend the treated silica particles rather than acetone. The fabric is pressed on the polyurethane coated surface and the resulting surface is cured at about 93° C. (about 200° F.) for an hour. The texture of the fabric is fully transferred to the polyurethane surface along with embedding of the nanoparticle in the polyurethane. Similar results are anticipated using rollers or stamps with other textures and/or patterns.

Test Results for Samples from Parts A-C

The PP sheets and the polyurethane coated aluminum plate prepared in parts A-C are tested for superhydrophobicity. The samples each have a contact angle with water over 150° and repels both water and chocolate syrup (an oily liquid). The PP sheets and the polyurethane coated aluminum plate prepared in parts A-C are also tested for resistance to the loss of superhydrophobic behavior due to abrasion using a Model 503 Taber Abraser. When fitted with CS-10 wheels and operated at 95 RPM with a 1,000 g load the samples all require more than 40 Abraser cycles to cause the loss of superhydrophobicity. The end of superhydrophobic behavior is judged by the failure of more half of the water droplets applied to the tested surface (typically 20) to run (roll) off when the surface is inclined at 3 degrees from horizontal.

### Example 2

### Preparation of Superhydrophobic Injection Molded Parts

The surfaces of a hardened steel mold used to form substantially planar plastic disks are sandblasted to produce a texture having an Ra=3 microns. The resulting mold is used to injection mold parts from polypropylene (PP), nylon, and polycarbonate. Prior to injection molding each of the different plastics, the mold is sprayed with the coating composition described in Example 1, part A. For each plastic, up to 25 parts displaying HP/OP properties can be formed using a single application of the coating composition.

The molding surfaces of the hardened steel mold that contact the injected plastic are again sandblasted to produce a surface texture having an Ra of ˜7 microns. The resulting mold is used to injection mold up to five parts from each of polypropylene (PP), nylon, and polycarbonate, which is followed by spraying the mold with the coating composition described in Example 1, Part A prior to the injection molding of each part.

Parts showing a water contact angle greater than 150° from both the Ra=3 microns and the Ra of ˜7 microns trials are tested for resistance to the loss of SH behavior due to surface wear. Abrasion testing data for the samples shows that samples prepared from molds with an Ra of about 7 microns resisted the loss of hydrophobic behavior 2 to 3 times better than samples prepared from molds with an Ra of about 3 microns. In addition polypropylene shows a greater resistance to the loss of SH behavior to abrasion than nylon or polycarbonate.

Parts from each of the trials are also tested for length of time to the loss of superhydrophobic behavior under a shower of water. Water is applied from a showerhead placed about 244 cm (96 inches) above the substantially planar test surface inclined at 3 degrees from the horizontal, the showerhead having 70 nozzles with a 1 mm diameter orifice arranged in 5 spokes of 5 nozzles and 15 spokes of 3 nozzles about a central point on the circular showerhead. The apparatus delivers a shower of about 6 liters of tap water per minute using about 137900 to about 310275 Pa (about 20 to about 45 psi) over an approximately circular area of about 150 cm in diameter at the level of the test surface. The time to loss of superhydrophobic behavior is determined to be the period of time after which water droplets from the shower begin to stick to the surface (no longer freely run off the surface) of a sample placed in the shower. Table 4 shows the approximate time (minutes) to loss of SH behavior under a shower of water for a series of injection molded parts prepared without recoating the mold for subsequent parts in the series. Nylon has a slightly higher resistance to the loss of SH behavior under a shower of water than polycarbonate or polypropylene. After drying, the SH behavior returns to all samples.

TABLE 4
Time (minutes) to the loss of SH behavior
for a series of molded plastic parts

Sample

| | PP | Nylon | Polycarbonate | PP |
|---|---|---|---|---|
| Part No | 3 μm | 3 μm | 3 μm | 7 μm |
| 1 | 150 | 180 | 120 | 270 |
| 2 | 95 | 150 | 90 | 210 |
| 3 | 90 | 122 | 35 | 160 |
| 4 | 72 | 120 | 34 | 160 |
| 5 | 70 | 93 | 33 | 130 |
| 6 | 34 | 89 | 30 | |
| 7 | 60 | 22 | 24 | |
| 8 | 55 | 20 | 23 | |
| 9 | 34 | | 20 | |
| 10 | 35 | | 21 | |
| 11 | 17 | | | |
| 12 | 18 | | | |
| 13 | 19 | | | |
| 14 | 20 | | | |
| 15 | 9 | | | |
| 16 | 5 | | | |

### Example 3

### Preparation of Superhydrophobic Rubber Sheets Using Sandblasted Metal Plates to Impart Texture

Two aluminum plates (5 inches×5 inches×0.125-inches) are sandblasted to a surface roughness (Ra) of about 7 microns. The sandblasted plates are lightly sprayed with a coating composition comprising acetone in which is suspended 1% w/v of M5 (fumed silica from Cabot, Billerica, Mass.) that is treated with tridecafluoro-1,1,2,2-tetrahyrctyltrichlorsilane (Gelest, Inc., Morrisville. PA).

Sheets of rubber measuring about 4 inches×about 4 inches are sandwiched between the plates with the sand blasted surfaces of the plates in contact with the rubber sheets. The sandwiched plates are processed at about 280° C. (525° F.) for about 7 minutes with about a 2.3 kg (about 5 lb) load applied during the heating cycle. Plates are cooled and the rubber sheets removed. The rubber samples have a water contact angle over 150° and repel both water and chocolate syrup.

1. A method of preparing hydrophobic (HP)/superhydrophobic (SH) and/or oleophobic (OP) surfaces on all or part of a molded object comprising:
a) applying a coating composition comprising second-particles and optionally comprising first-particles to all or part of the surface of a mold that will shape some or all of the object, thereby forming a coated mold surface; and
b) introducing a material to be molded into the mold in a flowable state, thereby contacting at least a portion of said material with said coated mold surface;
wherein said second particles comprise an oxide of a metal or metalloid oxide, and said second particles are functionalized with one or more independently silanes of formula I or siloxanes.

2. A method of preparing hydrophobic (HP)/superhydrophobic (SH) and oleophobic (OP), areas on all or part of the surface of pressed, rolled or stamped objects comprising:
a) applying a coating composition comprising second-particles and optionally comprising first-particles to all or part of the surface of either:
(i) the pressing, rolling or stamping surface that will contact the material to be formed into all or part of said object, or
(ii) the surface of the material to be pressed, rolled or stamped into all or part of said object; and
b) pressing, rolling or stamping the material to form all or part of said object;
wherein said second particles comprise an oxide of a metal or metalloid oxide, and said second particles are functionalized with one or more independently silanes of formula I or siloxanes.

3. The method of claim 1, wherein the mold, or the pressing, rolling or stamping surface, is textured by grinding, sandblasting, laser patterning, chemical etching, plasma spraying, or machining.

4. The method of claim 3, wherein the coating composition comprises second-particles suspended in a solvent.

5. The method of claim 4, wherein the second-particle concentration varies from about 1% to about 2% by weight of said coating composition.

6. The method of claim 4, wherein said solvent, comprises at least 1, 2, 5, 10, 20, 30, 40, 50, 60, 70, 80, 90, or 95% by weight of acetone, hexane, and/or MEK.

7. (canceled)

8. The method of claim 1, wherein said particles have a surface area from about 50 m2/g to about 500 m2/g.

9. The method of claim 1, wherein said second-particles are functionalized with one or more independently selected silanes of formula I.

10. The method of claim 1 wherein said coating composition further comprises first-particles.

11. The method of claim 10, wherein said surface of a molded object is formed by injection molding, blow molding, spin casting, or centrifugal casting and said first-particles have a melting point less than, or less than or equal to, the melting point of the material to be molded.

12. The method of claim 10, wherein said surface of a molded object is formed by injection molding, blow molding, or centrifugal casting, and said first-particles have a melting point greater than, or greater than or equal to, the melting point of the material to be molded.

13. The method of claim 1, wherein said material comprises: plastic, polyurethane, epoxy, acrylic, metal, or rubber.

14-18. (canceled)

19. The method of claim 1 wherein said material comprises a one-component or two component polyurethane, epoxy, and/or acrylic.

20-23. (canceled)

24. The method of claim 1, wherein said first-particles comprise a glass to yield reflective properties.

25. An object comprising a surface prepared by the method of claim 1.

26. The object according to claim 25, wherein said surface is comprised of: a plastic, polyurethane, epoxy, acrylic, metal, or rubber; and wherein said surface comprises first and second-particles.

27. (canceled)

29. The object of claim 25, wherein said object remains hydrophobic and/or oleophobic after any one or more of:
a) 10, 20, 30, 40 or 50 Taber cycles using CS10 wheels and a 1,000 g load at 95 rpm;
b) submersion in water at 40 psi of water pressure for over 7 days; or
c) exposure to a constant shower of water for 4 hours.

30. The method of claim 1 wherein the surface of the object is rendered both hydrophobic and oleophobic.

31-32. (canceled)

33. An object according to claim 25, wherein the surface of the object is rendered both hydrophobic and oleophobic.

34-35. (canceled)
